(19) United States
(12) Patent Application Publication
(10) Pub. No.: US 2006/0246372 A1
(43) Pub. Date: Nov. 2, 2006

(54) Planographic printing plate precursor

(75) Inventors: Ippei Nakamura, Shizuoka-ken (JP); Kazuto Kunita, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/081,587

(22) Filed: Mar. 17, 2005

(30) Foreign Application Priority Data
Mar. 17, 2004 (JP) 2004-076831

(51) Int. Cl. G03C 1/00

(52) U.S. Cl. 430/270.1

(57) ABSTRACT

The present invention relates to a positive planographic printing plate precursor comprising a support and a positive recording layer which is disposed on the support and contains (A) an alkali-soluble high-molecular weight compound having a heterocyclic ring bonded with a mercapto group. This positive planographic printing plate precursor is superior in chemical resistance and the developing characteristics of the exposed portions.

### CROSS-REFERENCE TO RELATED APPLICATION

This application claims priority under 35 USC 119 from Japanese Patent Application No. 2004-076831, the disclosure of which is incorporated by reference herein.

### BACKGROUND OF THE INVENTION

1. Field of the Invention

The present invention relates to a planographic printing plate precursor and, particularly, to a positive planographic printing plate precursor for so-called direct plate making, the precursor being capable of making a printing plate directly from digital signals of, for example, computers.

2. Description of the Related Art

The development of lasers in recent years has been significant. Particularly solid lasers, semiconductor lasers and gas lasers emitting ultraviolet light, visible light and infrared light having wavelength ranges from 300 nm to 1200 nm, with high output and small-size have become easily available. These lasers are very useful as recording light sources when making printing plates directly from digital data of, for example, computers.

Positive planographic printing plate precursors contain, as essential components, an alkali-soluble resin (binder resin) and a compound (development inhibitor), which interacts with the binder resin to reduce the solubility of the binder resin in a developer. Also, in the image-forming mechanism of the positive planographic printing plate precursor, energy such as light or heat is supplied to parts intended to be non-image portions to improve the solubility of these portions of a recording layer in a developer, thereby forming an image by making use of a difference in solubility between the image portions and the non-image portions.

Attention is focused particularly on infrared laser positive planographic printing plate precursors using infrared lasers having wavelengths of 760 nm to 1200 nm. Such infrared laser positive planographic printing plate precursors comprise a binder resin, an infrared absorbing agent that absorbs infrared light to generate heat and a development inhibitor as essential components.

Here, when an infrared absorbing agent having development-inhibitive ability is used, the essential components are only the binder resin and the infrared absorbing agent. Namely, this infrared absorbing agent serves as a development inhibitor that interacts with the binder resin to substantially reduce the solubility of the binder resin in a developer in the unexposed portions (image portions). In the exposed portions (non-image portions), for example, the interaction of IR dyes and the like with the binder resin is reduced by the generated heat, and these portions are dissolved in the developer to form an image.

In such positive planographic printing plate precursors, the solubility of the exposed portions (non-image portions) under some working conditions is not satisfactory, giving rise to the problem of poor development.

For example, when an infrared absorbing agent having dissolution inhibitive ability is used in the infrared laser positive planographic printing plate precursor, the infrared absorbing agent has a light-heat conversion effect in the exposed portion (non-image portion) and serves as a dissolution inhibitor in the unexposed portion (image portion) only. It does not have the ability to promote the dissolution of the exposed portion. Moreover, this method has the drawback that residual film can easily occur because the generated heat is diffused to a support near the boundary between the exposed portion and the support and there is therefore the case where inefficient heat is generated to form an image.

The following methods are proposed for the purpose of solving the above problems: a method in which a binder resin having high solubility in an alkali developer is used, and heat treatment is carried out to develop alkali resistance (see, for example, Japanese patent application Laid-Open (JP-A) No. 2001-520953); and a method in which a compound, such as a melamine derivative which has an amino group and is highly reactive, is added (see, for example, JP-A No. 11-202481).

These methods, however, have the problem that planographic printing plate precursors produced using these methods are inferior in chemical resistance because recording layers using materials having good solubility in alkali developer are chemically weakened in the image forming region (materials' having good solubility means they are easily damaged by developers, and ink cleaning solvents, plate cleaners and the like used during printing). In view of this situation, there is a strong requirement for a resin material which is superior in chemical resistance and durability in unexposed regions, and also has good developing characteristics after the dissolution inhibitive effect has been released by exposure.

### SUMMARY OF THE INVENTION

The present invention has been made in view of the above circumstances and provides a positive planographic printing plate precursor, which is superior in chemical resistance, and in the developing characteristics of the exposed portions.

The inventors of the invention have undertaken keen research to complete the invention and, as a result, found that the above problem can be solved using an alkali-soluble macromolecular compound having a specific structure as a component of the recording layer of a planographic printing precursor.

Specifically, the invention relates to a planographic printing plate precursor comprising a support and a positive recording layer which is disposed on the support and contains an alkali-soluble high-molecular weight compound (A) having a heterocyclic ring bonded with a mercapto group (hereinafter, referred to as “specific macromolecular compound” for convenience).

Moreover, in a preferred embodiment of the planographic printing plate precursor, the positive recording layer further contains an infrared absorbing agent (B) and is able to form an image by irradiation with infrared rays.

As mentioned in the related art, the so-called positive recording layer generally contains, in addition to the specific macromolecular compound (A) (binder resin), a compound (development inhibitor) which interacts with the specific macromolecular compound (A) to reduce the solubility to a developer. In many cases, the so-called positive recording layer include the infrared absorbing agent (B) which also has development inhibitive ability.

Also, the recording layer of the planographic printing plate precursor of the invention preferably has a multilayer structure constituted of plural layers of differing structural components. Particularly, it is preferable that the recording layer contains a lower layer, having the specific macromolecular compound (A), and an upper layer, having an alkali-soluble resin and a compound which interacts with the alkali-soluble resin to reduce the solubility in an alkali developer. It is more preferable that at least one of the upper layer or lower layer of the recording layer contains the infrared absorbing agent (B).

Although the action of the invention is not well known, it is inferred to be as follows.

It is inferred that, in the unexposed portions (image portions), the planographic printing plate precursor using, as a binder resin, the alkali-soluble macromolecular compound (A) having a heterocyclic ring bonded with a mercapto group, the macromolecular compound being the characteristic component of the invention, exhibits high chemical resistance due to the structure of the heterocyclic ring existing in the specific macromolecular compound. As a result, the planographic printing plate precursor of the invention exhibits high resistance to dissolution in generally used organic solvents, for example, ink cleaning solvents and plate cleaners which are used during printing.

It is also inferred that in the exposed portions (non-image portions), the mercapto group in the specific macromolecular compound exhibits high solubility in a high pH alkali aqueous solution such as a developer when the interaction between the specific macromolecular compound and the dissolution inhibitor is released. This gives the recording layer superiour developing characteristics. Such alkali solubility due to a mercapto group is not exhibited in a low pH alkali aqueous solution or water and therefore, the introduction of the mercapto group creates no concern of a deterioration in the chemical resistance and water resistance of the image portions.

It is therefore predicted that recording layers using the specific macromolecular compound: are superior in developing durability and chemical resistance in the unexposed portions, where high strength image portions which are resistant to the influence of damping water is formed; and exhibit high developing characteristics in the exposed portions.

Also, when the recording layer has a multilayer structure, as in a preferred embodiment of the invention, the aforementioned chemical resistance is sufficiently effective in the areas where the upper layer of the recording layer exists as an alkali-resistant layer to inhibit penetration of organic solvents and the like, whereby the areas become high strength image portions. However when the upper layer is removed in the non-image portions, the lower layer on the other hand is dissolved and dispersed by an alkali developer because of the aforementioned high solubility in a high pH alkali aqueous solution.

The invention can provide a positive planographic printing plate precursor, which has high chemical resistance and is superior in the developing characteristics of the exposed portions.

### DETAILED DESCRIPTION OF THE INVENTION

The planographic printing plate precursor of the present invention comprises a support and a positive recording layer, which is disposed on the support and contains an alkali-soluble macromolecular compound having a heterocycle bonded with a mercapto group (A).

It is preferable to add (B) an infrared absorbing agent, which absorbs infrared light to generate heat and to add a development inhibitor (C) for the purpose of improving the inhibition (dissolution inhibitive ability) of the recording layer.

Such a recording layer may have any layer structure without any particular limitation and may have a monolayer structure or a multilayer structure comprising plural layers differing in structural components. When the recording layer has a multilayer structure, the above component (A) may be contained in any layer: however it is preferably contained in a lower layer in particular from the viewpoint of the effect.

First, each structure of the planographic printing plate precursor having monolayer type recording layer according to the invention will be explained in detail one after another.

(Monolayer Type Recording Layer)

[(A) Specific Macromolecular Compound]

As the specific macromolecular compound used in the invention, any material may be used insofar as it is an alkali-soluble macromolecular compound having a heterocycle bonded with a mercapto group. The heterocycle bonded with a mercapto group is preferably bonded with the side chain of the specific macromolecular compound.

Here, the heterocycle bonded with a mercapto group is preferably an aromatic heterocycle from the viewpoint of further improving chemical resistance. It is more preferable that two or more of the atoms constituting the aromatic heterocyclic structure are atoms selected from a nitrogen atom, oxygen atom and sulfur atom and it is particularly preferable that three or more of the atoms constituting the aromatic heterocyclic structure are atoms selected from a nitrogen atom, oxygen atom and sulfur atom.

Anyway, the atomic group forming the aromatic heterocyclic structure preferably contains at least one nitrogen atom.

Specific examples of the heterocyclic structure include a pyrrole ring, pyrazole ring, imidazole ring, triazole ring, tetrazole ring, isooxazole ring, oxazole ring, oxadiazole ring, isothiazole ring, thiazole ring, thiadiazole ring, thiatriazole ring, indole ring, indazole ring, benzimidazole ring, benzotriazole ring, benzoxazole ring, benzthiazole ring, benzselenazole ring, benzothiadiazole ring, pyridine ring, pyridazine ring, pyrimidine ring, pyrazine ring, triazine ring, quinoline ring and quinoxaline ring. Preferable examples of the heterocyclic structure include imidazole ring, triazole ring, tetrazole ring, oxadiazole ring, thiadiazole ring, benzimidazole ring, benzotriazole ring and triazine ring and more preferable examples of the heterocyclic structure include thiadiazole ring, benzimidazole ring and triazine ring.

Preferable examples of the specific macromolecular compound may include macromolecular compounds having repeat units represented by the following formulae (1) to (4).

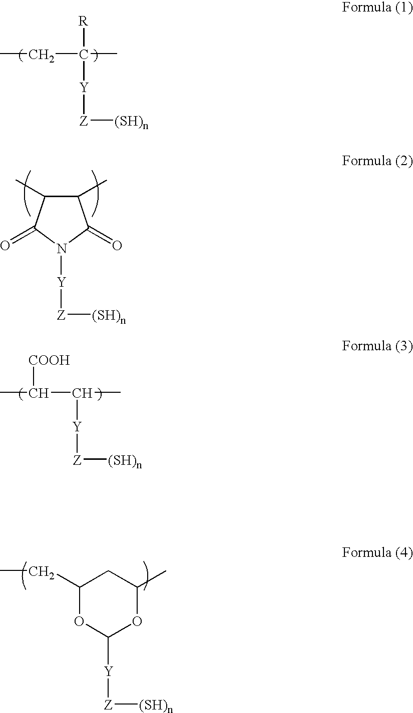

In the formula (1), R represents a hydrogen atom or a methyl group, Y represents a single bond or a divalent organic group, Z represents the aforementioned heterocyclic structure and n denotes an integer of 1 or 2. Here, the aforementioned Y is preferably a divalent organic group. As such a divalent organic group, an alkylene group, arylene group, aralkylene group, —COO—, —NHCOO—, —NHCOOC₂H₄— or —CONH— is preferable and an arylene group is more preferable.

In the formulae (2) to (4), Y, Z and n have the same meanings as those described in the formula (1).

The specific macromolecular compounds having the structural units represented by the formulae (1) to (4) may be synthesized using a method in which a heterocycle bonded with a mercapto group is introduced into a macromolecular compound which is a precursor by a polymer reaction or a method in which a monomer having a heterocycle bonded with a mercapto group is polymerized. Preferable examples of the monomer used when synthesizing the specific macromolecular compound by polymerization may include the following monomers, which are not intended to be limiting of the invention.

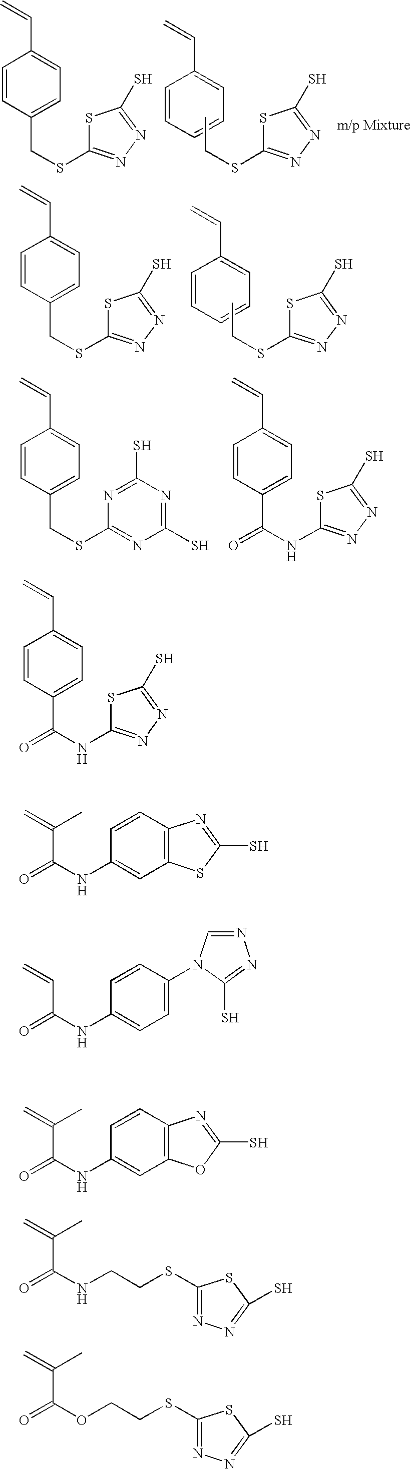

Only one or two or more of the structural units having a heterocycle bonded with a mercapto group may be contained in the specific macromolecular compound.

Here, the specific macromolecular compound may contain other copolymerizable components insofar as the effect of the invention is not impaired. In this case, the content of the structural unit having a heterocycle bonded with a mercapto group is preferably in a range from 10 to 80 mol % and more preferably in a range from 20 to 70 mol % in the specific macromolecular compound from the viewpoint of sensitivity and preserving stability. Also, the content of the above structural unit is preferably in a range from 0.1 to 5.0 mmol and more preferably in a range from 0.1 to 4.0 mmol per 1 g of the specific macromolecular compound.

Examples of the structural unit which may be combined with the structural unit having the heterocycle bonded with a mercapto group include structural units derived from known monomers such as acrylates, methacrylates, acrylamides, methacrylamides, vinyl esters, styrenes, acrylic acids, methacrylic acids, acrylonitrile, maleic acid anhydride and maleic acid imide.

Examples of the above acrylates include methylacrylate, ethylacrylate, (n- or i-)propylacrylate, (n-, i-, sec- or t-)butylacrylate, amylacrylate, 2-ethylhexylacrylate, dodecylacrylate, chloroethylacrylate, 2-hydroxyethylacrylate, 2-hydroxypropylacrylate, 5-hydroxypentylacrylate, cyclohexylacrylate, allylacrylate, trimethylolpropanemonoacrylate, pentaerythritol monoacrylate, glycidylacrylate, benzylacrylate, methoxybenzylacrylate, chlorobenzylacrylate, 2-(p-hydroxylphenyl)ethylacrylate, furfurylacrylate, tetrahydrofurfurylacrylate, phenylacrylate, chlorophenylacrylate and sulfamoylphenylacrylate.

Examples of the above methacrylates include methylmethacrylate, ethylmethacrylate, (n- or i-)propylmethacrylate, (n-, i-, sec- or t-)butylmethacrylate, amylmethacrylate, 2-ethylhexylmethacrylate, dodecylmethacrylate, chloroethylmethacrylate, 2-hydroxyethylmethacrylate, 2-hydroxypropylmethacrylate, 5-hydroxypentylmethacrylate, cyclohexylmethacrylate, allylmethacrylate, trimethylolpropanemethacrylate, pentaerythritol monomethacrylate, glycidylmethacrylate, methoxybenzylmethacrylate, chlorobenzylmethacrylate, 2-(p-hydroxylphenyl)ethylmethacrylate, furfurylmethacrylate, tetrahydrofurfurylmethacrylate, phenylmethacrylate, chlorophenylmethacrylate and sulfamoylphenylmethacrylate.

Examples of the above acrylamides include acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(p-hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide and N-hydroxyethyl-N-methylacrylamide.

Examples of the above acrylamides include methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacrylamide and N-hydroxyethyl-N-methylmethacrylamide.

Examples of the above vinyl esters include vinyl acetate, vinyl butyrate and vinyl benzoate.

Examples of the above styrenes include styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorostyrene, dichlorostyrene, bromostyrene, iodostyrene, fluorostyrene and carboxystyrene.

Among these monomers, acrylates, methacrylates, acrylamides, methacrylamides, vinyl esters, styrenes, acrylic acids, methacrylic acids and acrylonitriles having 20 or less carbon atoms are preferable.

Moreover, at least one of the aforementioned other structural units used in combination with the specific macromolecular compound is preferably a structural unit substituted with an alkali-soluble group selected from the group consisting of the following (1) to (6).

(1) Phenolic hydroxyl groups (—Ar—OH)

(2) Sulfonamide groups (—SO₂NH—R)

(3) Substituted sulfonamide type acid groups (hereinafter referred to as “active imide group”) (—SO₂NHCOR, —SO₂NHSO₂R and —CONHSO₂R)

(4) Carboxylic acid groups (—CO₂H)

(5) Sulfonic acid groups (—SO₃H)

(6) Phosphoric acid groups (—OPO₃H₂)

In the above (1) to (6), Ar represents a divalent aryl connecting group which may have a substituent and R represents a hydrogen atom or a hydrocarbon group which may have a substituent.

Among the structural units having an alkali-soluble group selected from the above (1) to (6), structural units having the phenolic hydroxyl groups (1), the sulfonamide groups (2) or the carboxylic acid groups (4) are preferable, and structural units having the phenolic hydroxyl groups (1) or the sulfonamide groups (2) as the alkali-soluble group are most preferable from the viewpoint of securing the ability to form a positive image.

There is no particular limitation to the structure of the specific macromolecular compound according to the invention. The specific macromolecular compound may be a linear polymer or a polymer having a branched structure and may also have a block structure or a graft structure in the case where it is copolymers having the aforementioned each structural unit.

Also, the weight average molecular weight of the specific macromolecular compound is preferably in a range from 2,000 to 1,000,000, more preferably in a range from 5,000 to 500,000 and still more preferably 10,000 to 300,000 from the viewpoint of the ability of forming a positive image and chemical resistance.

It is to be noted that the macromolecular compound having a heterocyclic structure bonded with a mercapto group is known and negative recording materials using polymers having such a structure are disclosed in, for example, the publication of JP-A No. 2001-75277. In the invention, it has been found that the macromolecular compound having such a structure is used as a binder for a positive recording layer which is quite different in image formation mechanism from the negative recording layer, thereby ensuring an improvement in the incompatibility between the chemical resistance of the image portion and the developing characteristics of the non-image portion, which incompatibility is a peculiar problem of a positive recording layer.

A preferable structure of the specific macromolecular compound in the invention will be exemplified together with its weight average molecular weight: however, the invention is not limited by these examples. The weight average molecular weight (Mw) described here is a value measured by a gel permeation chromatographic method.

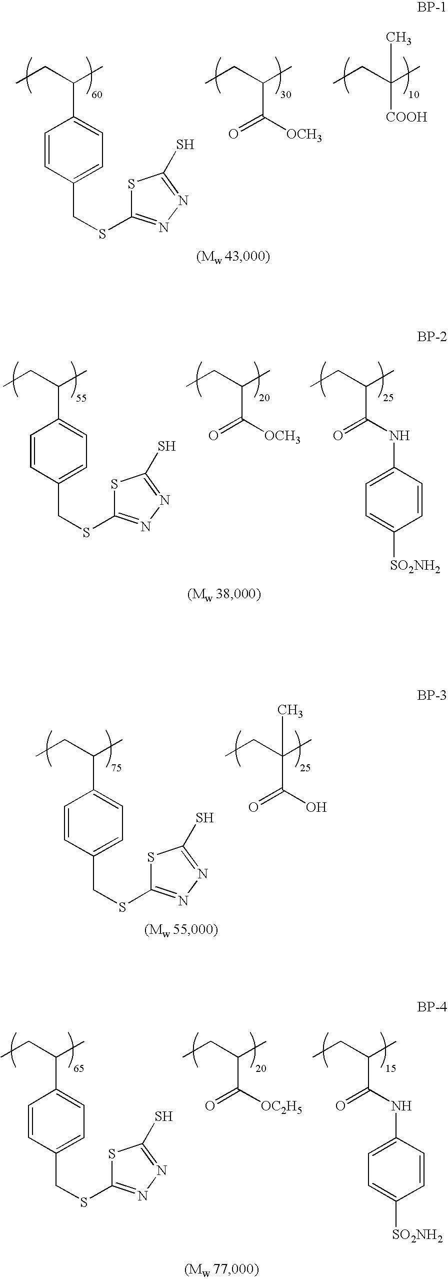

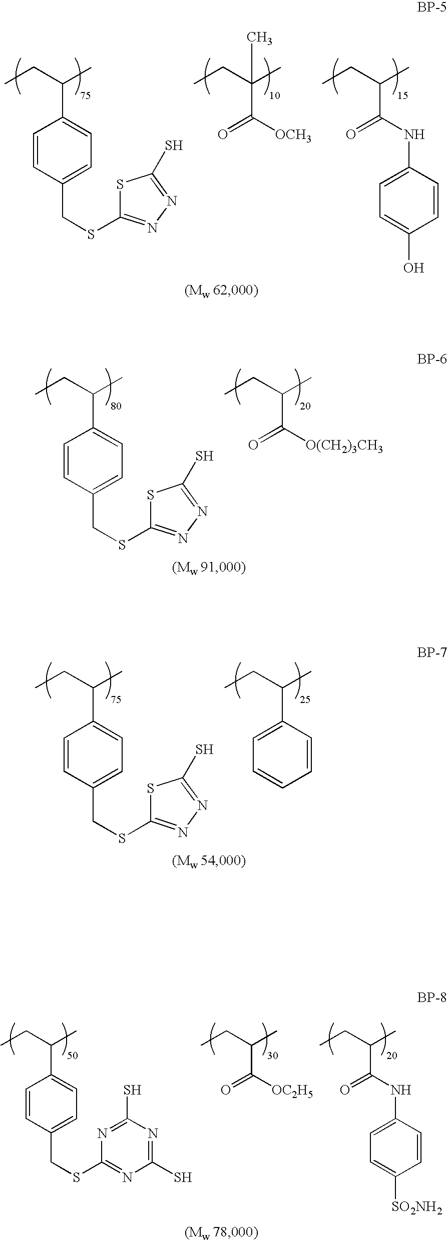

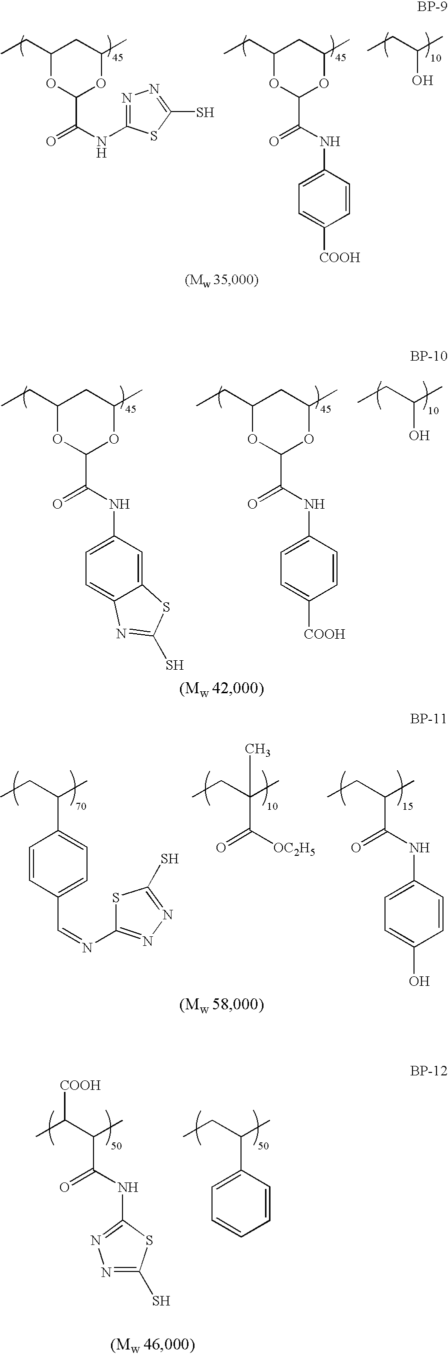

The specific macromolecular compound used in the invention may be synthesized using, for example, (A) the synthetic method described in each publication of JP-A Nos. 8-211614 and 8-304959, namely the method in which a polymerizable monomer having a heterocyclic structure (hereinafter referred to as “specified heterocyclic structure” if necessary) bonded with a mercapto group is synthesized and then the monomer is homo-polymerized or copolymerized with polymerizable monomers which are other copolymer components; or (B) a method in which a macromolecular compound having no specified heterocyclic structure is synthesized by a known synthetic method such as addition polymerization or polymerization condensation and then, a part having the specified heterocyclic structure is introduced into the macromolecular compound by a polymer reaction.

When the above method (A) is used to synthesize, it becomes difficult to control the molecular weight of the macromolecular compound and particularly difficult to increase the molecular weight by the influence of the chain transfer action of a mercapto group existing on the heterocycle of polymerizable monomer having the specified heterocyclic structure. It is therefore preferable to synthesize by the above method (B) to obtain the specific macromolecular compound having a proper molecular weight.

The macromolecular compound having no specified heterocyclic structure used in the case of synthesizing by the above method (B) preferably has a reactive part in its principal chain or side chain structure and more preferably has a reactive part in its side chain structure.

Preferable examples of the reactive part include various functional groups such as a halogen atom, e.g., a chlorine atom or bromine atom, hydroxyl group, amino group and isocyanate group. It is preferable to select a halogen atom and particularly a chlorine atom from the viewpoint of stability when synthesizing the macromolecular compound having no specified heterocyclic structure by polymerization and reactivity when introducing the specified heterocycle by a polymer reaction.

One example of a method of synthesizing the specific macromolecular compound using the synthetic method (B) will be shown below. However, the invention is not limited by this example.

(Synthesis of a Specific Macromolecular Compound BP-1)

<Synthesis of BP-1A>

9.2 g of p-chloromethylstyrene, 2.6 g of methylacrylate, 0.9 g of methacrylic acid and 0.14 g of an azo type initiator (trade name: V-601, manufactured by Wako Pure Chemical Industries, Ltd.) were dissolved in 30 g of N,N-dimethylacetamide. The solution was added dropwise to 30 g of N,N-dimethylacetamide heated to 80° C. with stirring in a nitrogen atmosphere over 2.5 Hrs. After the addition operation was finished, the mixture was heated with stirring continuously at 80° C. for 3 hours and at 90° C. for 1 Hr. After the reaction was finished, the reaction solution was cooled to ambient temperature to obtain 72 g of a solution of a macromolecular compound BP-1A (the following structure) having no heterocyclic structure bonded with a mercapto group.

<Synthesis of BP-1>

9.0 g of bismuthiol was mixed with 25 ml of N,N-dimethylacetamide. To the mixture was added 6.1 g of triethylamine with stirring under water-cooling, followed by continuing stirring for 15 minutes. Next, 72 g of the solution of the macromolecular compound BP-1A obtained above was added dropwise to the mixture over 30 minutes. After the addition was finished, the resulting mixture was stirred at ambient temperature for 3 hours. Then, the reaction solution was poured into 800 ml of water to precipitate a solid, which was then collected by filtration. The solid was washed with methanol and water and then dried, to obtain 19.2 g of a specific macromolecular compound BP-1 (the following structure). The weight average molecular weight of the resulting BP-1 was found to be about 43,000 (based on polystyrene) by measurement using gel permeation chromatography.

The synthetic scheme of the specific macromolecular compound BP-1 is shown below.

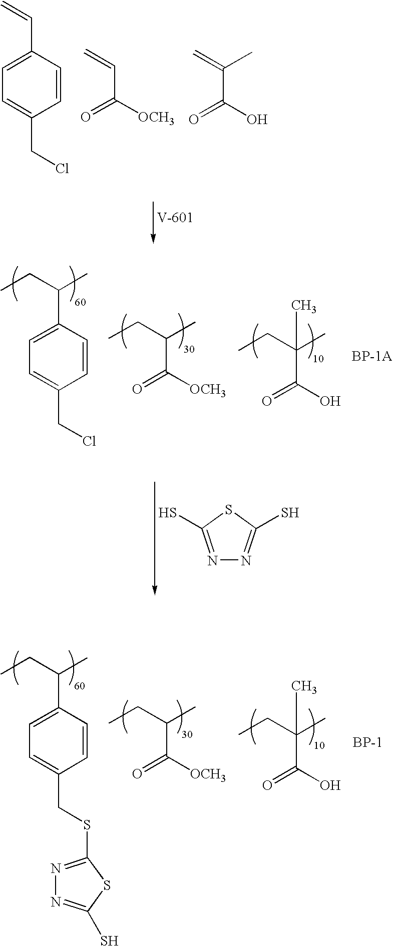

The content of the specific macromolecular compound in the monolayer recording layer of the planographic printing plate precursor of the invention is preferably 50 to 99 mass %, more preferably 60 to 97 mass % and particularly preferably 65 to 95 mass % in the total solid of the recording layer from the viewpoint of retaining the mechanical strength and chemical resistance of the recording layer.

Also, the monolayer type recording layer according to the invention may be compounded of an alkali-soluble resin other than the aforementioned specific macromolecular compound. Examples of the alkali-soluble resin which may be used together include usual alkali-soluble resins which are used in a multilayer type recording layer (upper layer) which will be explained later. Among these resins, novolac resins are preferable.

The ratio of the usual alkali-soluble resin to be mixed is preferably 40 mass % or less, more preferably 35 mass % or less and particularly preferably 30 mass % or less based on the whole alkali-soluble resin including the specific macromolecular compound.

[(B) Infrared Absorbing Agent]

The monolayer type recording layer according to the invention is preferably compounded of (B) an infrared absorbing agent. Any infrared absorbing agent may be used as the infrared absorbing agent used in the invention without any particular limitation insofar as it is a dye which absorbs infrared light to generate heat. Various dyes known as infrared absorbing agents may be used. Among these infrared absorbing agents, it is preferable to use infrared absorbing agents having the ability to interact on a binder resin such as the aforementioned specific macromolecular compound or a novolac resin to substantially reduce the solubility of the binder resin in a developer. For example, a cyanine dye is given as an example of the infrared absorbing agent having high dissolution inhibitive ability.

The infrared ray-absorbing dyes favorably used in the invention include commercially available dyes and publicly known dyes described in literature (e.g., “Dye manual”, the Society of Synthetic Organic Chemistry, Japan Ed., 1970). Specific examples thereof include azo dyes, metal complex salt azo dyes, pyrazolone azo dyes, anthraquinone dyes, phthalocyanine dyes, carbonium dyes, quinonimine dyes, methine dyes, cyanine dyes and the like. Among these dyes, dyes absorbing an infrared light or dyes absorbing a near-infrared light are particularly preferable in the invention, as they are suitable for use together with a laser having a wavelength in the infrared light or near-infrared region.

Typical examples of these infrared ray-absorbing dyes and near-infrared ray-absorbing dyes include cyanine dyes described in JP-A Nos. 58-125246, 59-84356, 59-202829 and 60-78787; methine dyes described in JP-A Nos. 58-173696, 58-181690, and 58-194595, and others; naphthoquinone dyes described in JP-A Nos. 58-112793, 58-224793, 59-48187, 59-73996, 60-52940, and 60-63744, and others; squarylium dyes described in JP-A No. 58-112792 and others; cyanine dye described in U.K. Patent No. 434,875; and the like.

Preferable examples of the dyes include infrared-absorbing sensitizers described in U.S. Pat. No. 5,156,938; arylbenzo(thio)pyrylium salts described in U.S. Pat. No. 3,881,924; trimethine thiapyrylium salts described in JP-A No. 57-142645; pyrylium compounds described in JP-A Nos. 58-181051, 58-220143, 59-41363, 59-84248, 59-84249, 59-146063, and 59-146061; cyanine dyes described in JP-A No. 59-216146; pentamethine thiopyrylium salts and the like described in U.S. Pat. No. 4,283,475; pyrylium compounds and the like described in Jan. Examined Patent Publication Nos. 5-13514 and 5-19702; commercial products such as Epolight III-178, Epolight III-130, and Epolight III-125 manufactured by Epolin, Inc.; and the like.

Other preferable examples thereof include infrared-absorbing dyes represented by Formulae (I) and (II) described in U.S. Pat. No. 4,756,993.

Also, these infrared absorbing agents may be added to either the same layer that is used as the recording layer or a layer formed separately. In the case of adding these infrared absorbing agents to the separate layer, the separated layer is preferably adjacent to the recording layer.

Moreover, when the infrared absorbing agent is a compound having dissolution inhibitive ability, the addition of the infrared absorbing agent to the same layer that contains the aforementioned specific macromolecular compound is preferable because the infrared absorbing agent not only has light-heat conversion ability but also functions as a development inhibitor.

The amount of the infrared absorbing agent to be added is preferably about 0.01 to 50 mass % and more preferably about 0.1 to 10 mass % based on the total solid content of the monolayer type recording layer from the viewpoint of sensitivity and durability (film characteristics).

[(C) Developing Inhibitor]

The recording layer of the invention is preferably blended with (C) a development inhibitor for the purpose of improving its inhibition (dissolution inhibitive ability). Particularly, in the case of using a compound having no dissolution inhibitive ability as the aforementioned infrared absorbing agent, this development inhibitor may be a component essential to retain the alkali resistance of the image portion.

Any material may be used as the development inhibitor used in the invention without any particular limitation insofar as it interacts on the aforementioned specific macromolecular compound or other alkali-soluble resin to substantially reduce the solubility of the alkali-soluble resin in a developer in the unexposed portion and allows the interaction to be weakened in the exposed portion so that the resin of the exposed portion is soluble in the developer. Particularly, a quaternary ammonium salt or a polyethylene glycol type compound is preferably used. Also, among image colorants which will be described later, there are compounds which function as the developing inhibitor and these compounds are also given as preferable examples of the development inhibitor.

The quaternary ammonium salt is not limited to specific kinds, and examples thereof include tetraalkylammonium, trialkylarylammonium, dialkyldiarylammonium, alkyltriarylammonium, tetaraarylammonium, cyclic ammonium, and bicyclic ammonium salts.

Specific examples thereof include tetrabutylammonium bromide, tetrapentylammonium bromide, tetrahexylammonium bromide, tetraoctylammonium bromide, tetralaurylammonium bromide, tetraphenylammonium bromide, tetranaphthylammonium bromide, tetrabutylammonium chloride, tetrabutylammonium iodide, tetrastearylammonium bromide, lauryltrimethylammonium bromide, stearyltrimethylammonium bromide, behenyltrimethylammonium bromide, lauryltriethylammonium bromide, phenyltrimethylammonium bromide, 3-trifluoromethylphenyltrimethylammonium bromide, benzyltrimethylammonium bromide, dibenzyldimethylammonium bromide, distearyldimethylammonium bromide, tristearylmethylammonium bromide, benzyltriethylammonium bromide, hydroxyphenyltrimethylammonium bromide and N-methylpyridinium bromide. In particular, quaternary ammonium salts disclosed in Japanese Patent Application Nos. 2001-226297, 2001-370059 and 2001-398047 are preferred.

The amount of the quaternary ammonium salt is preferably 0.1 to 25 mass % and more preferably 0.5 to 15 mass % based on the total solid content of the monolayer type recording layer from the viewpoint of development inhibitive effect and film-forming characteristics of the above alkali-soluble resin.

The polyethylene glycol type compound is not limited to specific kinds, and may be a compound having a structure represented by the following general formula (I):
R¹—{—O—(R³—O—)ₘ—R²}ₙ (I)

wherein R¹ represents a polyhydric alcohol residue or polyhydric phenol residue; R² represents a hydrogen atom, or an alkyl, alkenyl, alkynyl, alkyloyl, aryl or aryloyl group which may each have a substituent and each have 1 to 25 carbon atoms; R³ represents an alkylene group which may have a substituent; m and n are an integer of 10 or more and an integer of 1 or more and 4 or less, respectively, on average.

Examples of the polyethylene glycol type compound represented by the general formula (I) include polyethylene glycols, polypropylene glycols, polyethylene glycol alkyl ethers, polypropylene glycol alkyl ethers, polyethylene glycol aryl ethers, polypropylene glycol aryl ethers, polyethylene glycol alkylaryl ethers, polypropylene glycol alkylaryl ethers, polyethylene glycol glycerin esters, polypropylene glycol glycerin esters, polyethylene sorbitol esters, polypropylene glycol sorbitol esters, polyethylene glycol aliphatic acid esters, polypropylene glycol aliphatic acid esters, polyethylene glycolized ethylenediamines, polypropylene glycolized ethylenediamines, polyethylene glycolized diethylenetriamine, and polypropylene glycolized diethylenetriamines.

Specific examples thereof include polyethylene glycol 1000, polyethylene glycol 2000, polyethylene glycol 4000, polyethylene glycol 10000, polyethylene glycol 20000, polyethylene glycol 5000, polyethylene glycol 100000, polyethylene glycol 200000, polyethylene glycol 500000, polypropylene glycol 1500, polypropylene glycol 3000, polypropylene glycol 4000, polyethylene glycol methyl ether, polyethylene glycol ethyl ether, polyethylene glycol phenyl ether, polyethylene glycol dimethyl ether, polyethylene glycol diethyl ether, polyethylene glycol diphenyl ether, polyethylene glycol lauryl ether, polyethylene glycol dilauryl ether, polyethylene glycol nonyl ether, polyethylene glycol cetyl ether, polyethylene glycol stearyl ether, polyethylene glycol distearyl ether, polyethylene glycol behenyl ether, polyethylene glycol dibehenyl ether, polypropylene glycol methyl ether, polypropylene glycol ethyl ether, polypropylene glycol phenyl ether, polypropylene glycol dimethyl ether, polypropylene glycol diethyl ether, polypropylene glycol diphenyl ether, polypropylene glycol lauryl ether, polypropylene glycol dilauryl ether, polypropylene glycol nonyl ether, polyethylene glycol acetyl ester, polyethylene glycol diacetyl ester, polyethylene glycol benzoic acid ester, polyethylene glycol lauryl ester, polyethylene glycol dilauryl ester, polyethylene glycol nonylic acid, polyethylene glycol cetylic acid ester, polyethylene glycol stearoyl ester, polyethylene glycol distearoyl ester, polyethylene glycol behenic acid ester, polyethylene glycol dibehenic acid ester, polypropylene glycol acetyl ester, polypropylene glycol diacetyl ester, polypropylene glycol benzoic acid ester, polypropylene glycol dibenzoic acid ester, polypropylene glycol lauric acid ester, polypropylene glycol dilauric acid ester, polypropylene glycol nonylic acid ester, polyethylene glycol glycerin ether, polypropylene glycol glycerin ether, polyethylene glycol sorbitol ether, polypropylene glycol sorbitol ether, polyethylene glycolized ethylenediamine, polypropylene glycolized ethylendiamine, polyethylene glycolized diethylenetriamine, polypropylene glycolized diethylenetriamine, and polyethylene glycolized pentamethylenehexamine.

The amount of the polyethylene glycol type compound is preferably 1 to 25 mass % and more preferably 3 to 15 mass % based on the total solid content of the monolayer type recording layer from the viewpoint of development inhibitive effect and image forming characteristics.

Also, when some measures are taken to raise the inhibition (dissolution inhibitive ability), a reduction in sensitivity is caused. In this case, it is effective to add a lactone compound in the recording layer with the intention of limiting the reduction in sensitivity. It is considered that when the developer penetrates into the exposed portion, namely, the recording layer of the area where the inhibition is made ineffective, this lactone compound reacts with a developer to generate a carboxylic acid compound newly, thereby promoting the dissolution of the recording layer of the exposed area, resulting in improved sensitivity. In the unexposed portion, the lactone compound and a polar group in the alkali-soluble resin, for example, a hydroxyl group in a novolac resin interact on each other and also the lactone compound exists stably in the film owing to its bulky structure with a ring. Therefore, even if an alkali developer is in contact with the surface of the unexposed portion, the developing resistance of the area is not reduced because a rapid ring-opening reaction of the lactone ring during developing is suppressed. This interaction is released by exposure or heating more easily than the inhibitive action of the aforementioned development inhibitor and the ring-opening reaction of the lactone compound in the exposed portion is therefore run rapidly.

Such a lactone compound is not limited to specific kinds. Examples thereof include compounds by the following general formulae (L-1) and (L-II):

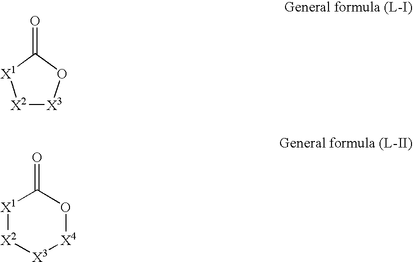

In the general formulae (L-I) and (L-II), X¹, X², X³ and X⁴ may be the same or different, and each represent a bivalent nonmetallic atom or nonmetallic atomic group which constitutes a part of the ring. These may each independently have a substituent. It is preferable that at least one of X¹, X² and X³ in the general formula (L-I), and at least one of X¹, X², X³ and X⁴ in the general formula (L-II) each have an electron withdrawing substituent or a substituent substituted with an electron withdrawing group.

The nonmetallic atom or nonmetallic atomic group is preferably an atom or atomic group selected from methylene, sulfinyl, carbonyl, thiocarbonyl, and sulfonyl groups, and sulfur, oxygen and selenium atoms, and is more preferably an atomic group selected from methylene, carbonyl and sulfonyl groups.

The electron withdrawing substituent (or group) referred to in the invention means a group having a positive Hammett substituent constant σp. About the Hammett substituent constant, the following can be referred to: Journal of Medicinal Chemistry, 1973, Vol. 16, No. 11, 1207-1216, and so on. Examples of the electron withdrawing group having a positive Hammett substituent constant σp include halogen atoms (such as a fluorine atom (σp value: 0.06), a chlorine atom (σp value: 0.23), a bromine atom (σp value: 0.23) and a iodine atom (σp value: 0.18)); trihaloalkyl groups (such as tribromomethyl (σp value: 0.29), trichloromethyl (σp value: 0.33), and trifluoromethyl (σp value: 0.54)); a cyano group (σp value: 0.66); a nitro group (σp value: 0.78); aliphatic, aryl or heterocyclic sulfonyl groups (such as methanesulfonyl (σp value: 0.72)); aliphatic, aryl or heterocyclic acyl groups (such as acetyl (σp value: 0.50) and benzoyl (σp value: 0.43)); alkynyl groups (such as C≡CH (σp value: 0.23)); aliphatic, aryl or heterocyclic oxycarbonyl groups (such as methoxycarbonyl (σp value: 0.45) and phenoxycarbonyl (σp value: 0.44)); and a carbamoyl group (σp value: 0.36); a sulfamoyl group (σp value: 0.57); a sulfoxide group; heterocyclic groups; an oxo group; and a phosphoryl groups.

Preferable examples of the electron withdrawing group include an amide group, an azo group, a nitro group, fluoroalkyl groups having 1 to 5 carbon atoms, a nitrile group, alkoxycarbonyl groups having 1 to 5 carbon atoms, acyl groups having 1 to 5 carbon atoms, alkylsulfonyl groups having 1 to 9 carbon atoms, arylsulfonyl groups having 6 to 9 carbon atoms, alkylsulfinyl groups having 1 to 9 carbon atoms, arylsulfinyl groups having 6 to 9 carbon atoms, arylcarbonyl groups having 6 to 9 carbon atoms, thiocarbonyl groups, fluorine-containing alkyl groups having 1 to 9 carbon atoms, fluorine-containing aryl groups having 6 to 9 carbon atoms, fluorine-containing allyl groups having 3 to 9 carbon atoms, an oxo group, and halogen atoms. More preferable examples of the electron withdrawing group include a nitro group, fluoroalkyl groups having 1 to 5 carbon atoms, a nitrile group, alkoxycarbonyl groups having 1 to 5 carbon atoms, acyl groups having 1 to 5 carbon atoms, arylsulfonyl groups having 6 to 9 carbon atoms, arylcarbonyl groups having 6 to 9 carbon atoms, an oxo group, and halogen atoms.

Specific examples of the compounds represented by the general formulae (L-I) and (L-II) are illustrated below. In the invention, however, the compounds are not limited to these compounds.

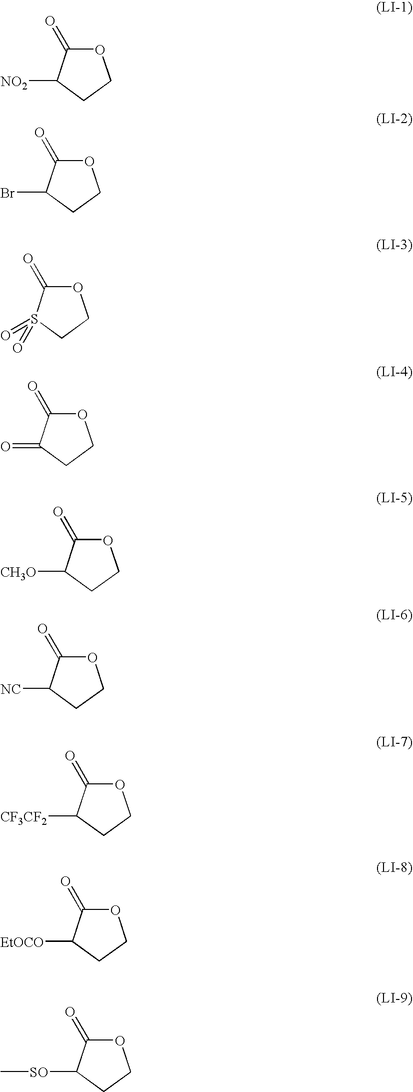

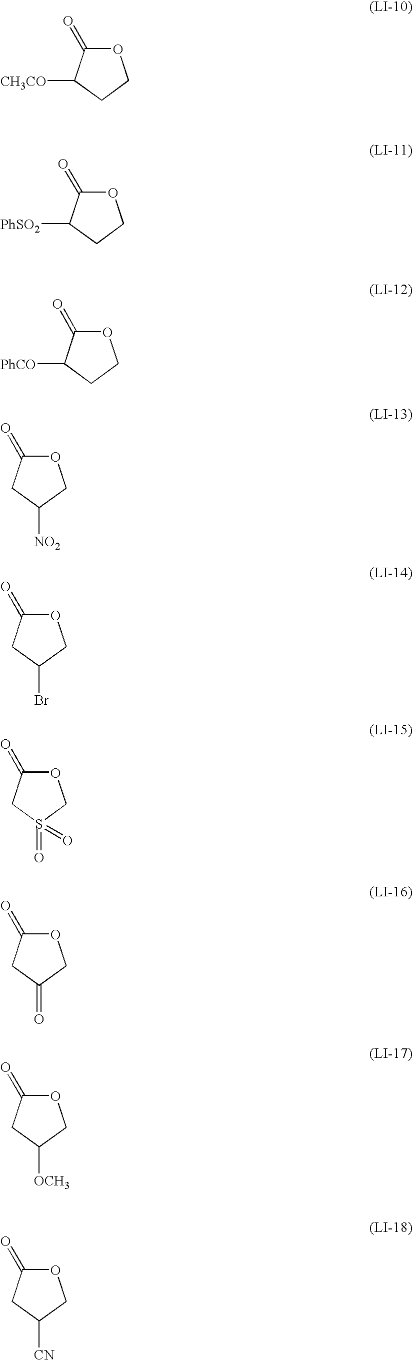

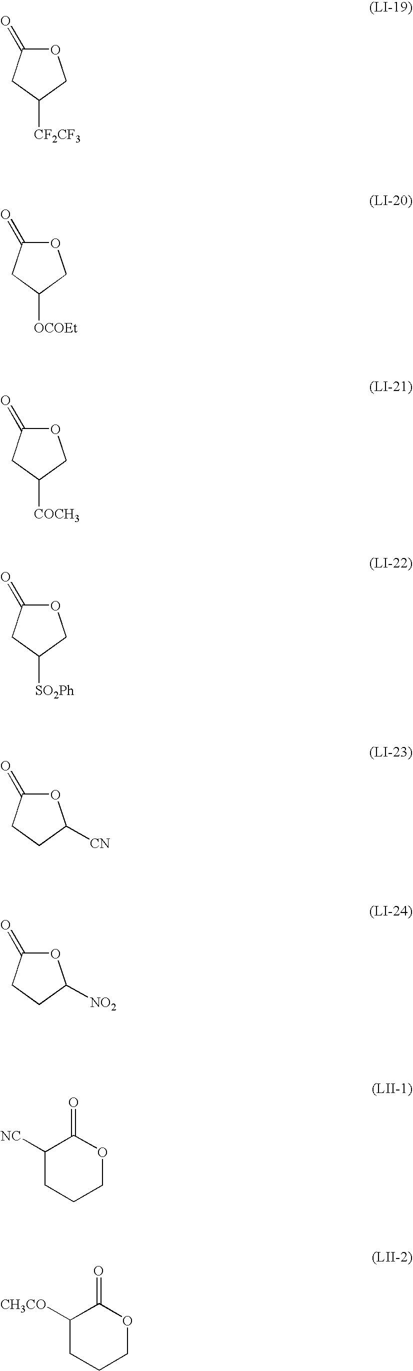

The (solid) amounts to be added, of the compounds represented by the general formulae (L-I) and (L-II), is preferably from 0.1 to 50% by mass, more preferably from 1 to 30% by mass of all solid contents of the upper layer, from the viewpoints of the better effects thereof.

The lactone compounds in the invention may be used alone or in combination of two or more thereof. In the case of using two or more types of the compounds represented by the general formula (L-I) or two or more types of the compounds represented by the general formula (L-II), the ratio between the added amounts of the these compounds may be arbitrary set if the total added amount of the compounds is within the above-mentioned range.

Further, it is desirable to use in combination a substance that is thermally decomposable and that substantially lowers the solubility of the alkali-soluble resin in an undecomposed state, such as onium salts, o-quinonediazide compounds, aromatic sulfone compounds and aromatic sulfonate compounds, in order to improve the inhibition of image areas to a developer.

Examples of the onium salts used in the invention include diazonium salts, ammonium salts, phosphonium salts, iodonium salts, sulfonium salts, selenonium salts, and arseninum salts.

Particularly preferable examples thereof include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al, Macromolecules, 17, 2468 (1984), C. S. Wen et al., The, Proc. Conf. Rad. Curing ASIA p. 478, Tokyo, October (1988), and U.S. Pat. Nos. 4,069,055 and 4,069,056; iodonium salts described in J. V. Crivello et al., Macromolecules, 10(6), 1307 (1977), Chem. & Eng. News, November 28, p. 31 (1988), EP No. 104,143, U.S. Pat. No. 5,041,358, EP No. 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 4,491,628, 4,760,013, 4,734,444 and 2,833,827, and DE Patents Nos. 2,904,626, 3,604,580, 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); and arsenonium slats described in C. S. Wen et al., The, Proc. Conf. Rad. Curing ASIA p. 478 Tokyo, Oct. (1988).

Of these onium salts, diazonium salts are particularly preferable. Particularly preferable examples of the diazonium salts include salts described in JP-A No. 5-158230.

Examples of the counter ion for the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and paratoluenesulfonic acid ions. Among these, hexafluorophosphoric acid and alkylaromatic sulfonic acids, such as triisopropylnaphthalenesulfonic acid and 2,5-dimethylbenzenesulfonic acid, are particularly preferred.

The quinonediazide compounds are preferably o-quinonediazide compounds. The o-quinonediazide compounds are compounds which each have at least one o-quinonediazide group and each have alkali-solubility increased by being thermally decomposed, and which may have various structures. In other words, the o-quinonediazide compounds assist the dissolution of the upper layer by both of the effect that the compounds are thermally decomposed so that their inhibition for the developing inhibitor is lost and the effect that the o-quinonediazide compounds themselves change to alkali-soluble substances.

Such an o-quinonediazide compound may be, for example, a compound described in J Cohser “Light-Sensitive Systems” (John & Wiley & Sons. Inc.), pp. 339-352. Particularly preferable is a sulfonic acid ester or sulfonamide of o-quinonediazide, which is obtained by reacting the o-quinonediazide with an aromatic polyhydroxy compound or aromatic amino compound. Preferable are also an ester made from benzoquinone-(1,2)-diazidesulfonic acid chloride or naphthoquinone-(1,2)-diazide-5-sulfonic acid chloride and pyrogallol-acetone resin, described in Japanese Patent Application Laid-Open (JP-B) No. 43-28403; an ester made from benzoquinone-(1,2)-diazidesulfonic acid chloride or naphthoquinone-(1,2)-diazide-5-sulfonic acid chloride and phenol-formaldehyde resin, described in U.S. Pat. Nos. 3,046,120 and 3,188,210.

Furthermore, preferable are an ester made from naphthoquinone-(1,2)-diazide-4-sulfonic acid chloride and phenol formaldehyde resin or cresol-formaldehyde resin, and an ester made from naphthoquinone-(1,2)-diazide-4-sulfonic acid chloride and pyrogallol-acetone resin. Other useful o-quinonediazide compounds are reported and disclosed in many examined or unexamined patent documents, for example, JP-A Nos. 47-5303, 48-63802, 48-63803, 48-96575, 49-38701 and 48-13354, JP-B Nos. 41-11222, 45-4610 and 49-17481, U.S. Pat. Nos. 2,797,213, 3,454,400, 3,544,323, 3,573,917, 3,674,495 and 3,785,825, GB Patents Nos. 1,227,602, 1,251,345, 1,267,005, 1,329,888 and 1,330,932, and DE Patent No. 854,890.

The added amount of the o-quinonediazide compound is preferably from 0.1 to 8% by mass, more preferably from 0.2 to 5% by mass of all solid contents of the monolayer-type recording layer. The above-mentioned o-quinonediazide compounds may be used alone or in a mixture form.

An alkali-soluble resin that has been at least partially esterified, as disclosed in JP-A No. 11-288089, may also be included.

In order to strengthen the inhibition on the surface of the recording layer and to strengthen scratch resistance on the surface, it is desirable to use in combination a polymer containing, as a polymerization component, a (meth)acrylate monomer having two or three perfluoroalkyl groups having from 3 to 20 carbon atoms in the molecule, as disclosed in JP-A No. 2000-187318.

The amount of the polymer added is preferably from 0.5 to 15% by mass, and more preferably from 1 to 10% by mass, based on the total solid content of the monolayer-type recording layer.

[Other Additives]

Upon forming the lower layer and the upper layer of the recording layer, various kinds of additives may further be added, depending on necessity, in addition to the aforementioned essential components, as long as the effect of the invention is not thereby impaired.

(Development Accelerator)

For improvement in sensitivity, an acid anhydride, a phenol compound and an organic acid may be added to the upper layer and/or the lower layer of the recording layer of the invention.

As the acid anhydride, cyclic acid anhydrides are preferred. Specific examples of the cyclic acid anhydrides include phthalic anhydride, tetrahydrophthalic anhydride, hexahydrophthalic anhydride, 3,6-endoxy-tetrahydrophthalic anhydride, tetrachlorophthalic anhydride, maleic anhydride, chloromaleic anhydride, a-phenylmaleic anhydride, succinic anhydride and pyromellitic anhydride as described in U.S. Pat. No. 4,115,128. Examples of acyclic acid anhydrides include acetic anhydride.

Examples of the phenols include, bisphenol A, 2,2′-bishydroxysulfone, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane, and the like.

Additionally, examples of the organic acids include the sulfonic acids, sulfinic acids, alkylsulfuric acids, phosphonic acids, phosphoric acid esters and carboxylic acids described in JP-A Nos. 60-88942 and 2-96755, and others, and specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluyl acid, 3,4-dimethoxybenzoic acid, phthalic acid, terephthalic acid, 4-cyclohexene-1,2-dicarboxylic acid, erucic acid, lauric acid, n-undecane acid, ascorbic acid, and the like.

The content of the acid anhydride, the phenol compound and the organic acid is preferably from 0.05 to 20% by mass, more preferably from 0.1 to 15% by mass, and particularly preferably from 0.1 to 10% by mass, based on the total solid contents of the monolayer-type recording layer.

(Surfactant)

For improvement of coatability and enhancement of stability of processing with respect to developing conditions, the monolayer-type recording layer of the invention may contain a nonionic surfactant such as those disclosed in JP-A Nos. 62-251740 and 3-208514, an amphoteric surfactant such as those disclosed in JP-A Nos. 59-121044 and 4-13149, a siloxane compound such as those disclosed in EP-A No. 950517, and a copolymer of fluorine-containing monomers as disclosed in JP-A Nos. 62-170950 and 11-288093 and Japanese Patent Application No. 2001-247351.

Specific examples of the nonionic surfactant include sorbitan tristearate, sorbitan monopalmitate, sorbitan trioleate, monoglyceride stearate, and polyoxyethylene nonyl phenyl ether. Specific examples of the amphoteric surfactant include alkyldi(aminoethyl)glycine, alkylpolyaminoethylglycine hydrochloride, 2-alkyl-N-carboxyethyl-N-hydroxyethylimidazolium betaine, and N-tetradecyl-N,N-betaine type surfactants (trade name: “Amorgen K”, manufactured by Daiichi Kogyo Co., Ltd., and others).

The siloxane compound is preferably a block copolymer of dimethylsiloxane and polyalkylene oxide. Specific examples thereof include polyalkylene oxide modified silicones (trade names: DBE-224, DBE-621, DBE-712, DBP-732 and DBP-534 (trade name, manufactured by Chisso Corp.), and Tego Glide 100 (trade name, manufactured by Tego Co. in Germany)).

The content of the nonionic surfactant and the amphoteric surfactant in the monolayer-type recording layer is preferably from 0.01 to 15% by mass, more preferably from 0.1 to 5% by mass, and even more preferably from 0.05 to 0.5% by mass, based on the total solid contents of the monolayer-type recording layer.

(Printing-Out Agent/Image Coloring Agent)

The monolayer-type recording layer of the invention may contain a printing-out agent for obtaining visible images immediately after heating by exposure, and a dye and a pigment may be added as an image coloring agent.

A typical example of the printing-out agent is a combination of a compound which releases an acid by being heated by exposure to light (optically acid-releasing agent) with an organic dye which can form a salt. Specific examples thereof include combinations of o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in JP-A Nos. 53-36223, 54-74728, 60-3626, 61-143748, 61-151644 and 63-58440. The trihalomethyl compound is an oxazole type compound or a triazine type compound. Either of these compounds are excellent in stability over time and can give vivid printed-out images.

The image coloring agent may be the above-mentioned salt-formable organic dye or some other dye than the salt-formable organic dye, and is preferably an oil-soluble dye or a basic dye. Specific examples thereof include Oil Yellow #101, Oil Yellow #103, Oil Pink #312, Oil Green BG, Oil Blue BOS, Oil Blue #603, Oil Black BY, Oil Black BS, and Oil Black T-505 (trade name, manufactured by Orient Chemical Industries Ltd.), Victoria Pure Blue, Crystal Violet Lactone, Crystal Violet (CI42555), Methyl Violet (CI42535), Ethyl Violet, Rhodamine B (CI145170B), Malachite Green (CI42000), and methylene Blue (CI52015). Dyes described in JP-A No. 62-293247 are particularly preferable.

These dyes may be added to the monolayer-type recording layer in an amount of from 0.01 to 10% by mass, and preferably from 0.1 to 3% by mass, based on the total solid contents of the monolayer-type recording layer.

(Plasticizer)

The monolayer-type recording layer of the recording layer of the invention may contain a plasticizer for imparting flexibility to a coating film. Examples thereof include butylphthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate and an oligomer or a polymer of acrylic acid or methacrylic acid.

The plasticizer may be added to the monolayer-type recording layer in an amount of from 0.5 to 10% by mass, and preferably from 1.0 to 5% by mass, based on the total solid contents of the monolayer-type recording layer.

(Wax)

To the monolayer-type recording layer of the invention, a compound that lowers a static friction coefficient of the surface may be added in order to impart scratch resistance. Specific examples of the compound include compounds having an ester of a long-chain alkyl carboxylic acid as disclosed in U.S. Pat. No. 6,117,913 and Japanese Patent Application Nos. 2001-261627, 2002-032904 and 2002-165584.

The amount of the wax added is preferably from 0.1 to 10% by mass, and more preferably from 0.5 to 5% by mass, based on the total solid contents of the monolayer-type recording layer.

(Multilayer Type Recording Layer)

Next, explanations will be furnished as to the case where the positive recording layer of the planographic printing plate precursor of the invention has a multilayer structure comprising plural layers differing in structural components.

In the multilayer type recording layer according to the invention, the aforementioned specific macromolecular compound (A) which is a characteristic component in the invention is preferably contained in the lower layer though it may be contained in any layer. Namely, the multilayer recording layer according to the invention is preferably a positive recording layer comprising the lower layer containing the specific macromolecular compound (A) and the upper layer containing an alkali-soluble resin and a compound which interacts on the alkali-soluble resin to reduce the solubility of the alkali-soluble resin in an alkali developer. It is more preferable that at least one of the lower layer and upper layer contains the infrared absorbing agent (B).

The multilayer type recording layer like this will be explained in detail.

-Lower Layer-

The lower layer according to the invention comprises the aforementioned specific macromolecular compound. Any material may be used as the specific macromolecular compound (A) without any particular limitation insofar as it has a heterocycle bonded with a mercapto group in its molecule.

The content of the specific macromolecular compound in the lower layer of the multilayer type recording layer is preferably 50 to 99 mass %, more preferably 65 to 97 mass % and particularly preferably 75 to 95 mass % based on the total solid content of the lower recording layer from the view point of retaining the mechanical strength and chemical resistance of the recording layer.

In the lower layer of the multilayer type recording layer, such a specific macromolecular compound may be only used as the binder resin. However, in addition to the aforementioned specific macromolecular compound, other resins may be used together to the extent that the effect of the invention is not impaired, from the viewpoint of improving film characteristics. Because it is required for the lower layer itself to exhibit alkali-solubility in, particularly, the non-image area, it is necessary to select a resin which does not impair this characteristics.

From the above point of view, examples of the resin which may be used together include alkali-soluble resins other than the aforementioned specific macromolecular compound. Examples of the alkali-soluble resins which may be used in combination with the specific macromolecular compound include general alkali-soluble resins which will be explained later as the components used in the upper layer. Among these examples, preferable examples may include polyamide resins, epoxy group-containing resins, polyvinylacetal resins, acryl resins, methacryl resins, polystyrene resins, novolac type phenol resins and polyurethane resins.

The ratio of the general alkali-soluble resin to be blended is preferably 40 mass % or less, more preferably 35 mass % or less and particularly preferably 30 mass % or less based on the whole alkali-soluble resin contained in the lower layer.

An infrared absorbing agent and other additives may be used as components contained in the lower layer according to the invention as required. Examples of these other additives include a developing promoter, surfactant, printout agent/colorant, plasticizer and WAX agent. The details of these components are the same as those described as the components of the upper layer as will be explained later.

-Upper Layer-

The upper layer according to the invention comprises an alkali-soluble resin and a compound which interacts on the alkali-soluble resin to reduce the solubility of the alkali-soluble resin in an alkali developer.

[Alkali-Soluble Resin]

The alkali-soluble resin that may be used in the upper layer of the invention is not particularly limited insofar as it has such characteristics as being soluble in an alkali developer upon contact therewith, and preferable examples are a homopolymer containing an acidic group in a main chain and/or a side chain of the polymer, and a copolymer or a mixture thereof. The specific macromolecular compound described above may be added to the upper layer.

Particular examples of the alkali-soluble resin having an acid group include macromolecular compounds having any one of functional groups such as (1) a phenolic hydroxyl group, (2) a sulfonamide group, (3) an active imide group, (4) a carboxylic acid group and (5) a phosphoric acid group in its molecule. Among these compounds, macromolecular compounds having (1) a phenolic hydroxyl group, (2) a sulfonamide group or (3) an active imide group are particularly preferable. As such a macromolecular compound, the following compounds may be given as examples. However, these compounds are not intended to be limiting of the invention.

(1) Examples of the macromolecular compounds comprising phenolic hydroxyl group may include novolak resin such as condensation polymers of phenol and formaldehyde, condensation polymers of m-cresol and formaldehyde, condensation polymers of p-cresol and formaldehyde, condensation polymers of m-/p-mixed cresol and formaldehyde, and condensation polymers of phenol/cresol (m-, p-, or m-/p-mixture) and formaldehyde; and condensation copolymers of pyrogallol and acetone.

As the macromolecular compound having a phenolic hydroxyl group, aside from the aforementioned examples, it is preferable to use macromolecular compounds having a phenolic hydroxyl group at their side chains. Examples of the macromolecular compound having a phenolic hydroxyl group at its side chain include macromolecular compounds obtained by homopolymerizing a polymerizable monomer comprising a low-molecular compound having one or more phenolic hydroxyl groups and one or more polymerizable unsaturated bonds or copolymerizing this monomer with other polymerizable monomers.

Examples of the polymerizable monomer having a phenolic hydroxyl group include acrylamides, methacrylamides, acrylates and methacrylates each having a phenolic hydroxyl group or hydroxystyrenes. Specific examples of the polymerizable monomer which may be preferably used include N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenylacrylate, m-hydroxyphenylacrylate, p-hydroxyphenylacrylate, o-hydroxyphenylmethacrylate, m-hydroxyphenylmethacrylate, p-hydroxyphenylmethacrylate, o-hydroxystyrene, m-hydroxystyrene, p-hydroxystyrene, 2-(2-hydroxyphenyl)ethylacrylate, 2-(3-hydroxyphenyl)ethylacrylate, 2-(4-hydroxyphenyl)ethylacrylate, 2-(2-hydroxyphenyl)ethylmethacrylate, 2-(3-hydroxyphenyl)ethylmethacrylate and 2-(4-hydroxyphenyl)ethylmethacrylate. Two or more types of these resins having phenolic hydroxyl group may be used in combination. Moreover, condensation polymers of phenols having an alkyl group having 3 to 8 carbon atoms as a substituent and formaldehyde, such as a t-butylphenol formaldehyde resin and octylphenol formaldehyde resin as described in the specification of U.S. Pat. No. 4,123,279 may be used together.

(2) Examples of the alkali-soluble macromolecular compound having a sulfonamide group include macromolecular compounds obtained by homopolymerizing polymerizable monomers having a sulfonamide group or by copolymerizing the monomer with other polymerizable monomers. Examples of the polymerizable monomer having a sulfonamide group include polymerizable monomers comprising a low-molecular compound having, in one molecule thereof, one or more sulfonamide groups —NH—SO₂— in which at least one hydrogen atom is added to a nitrogen atom and one or more polymerizable unsaturated bonds. Among these compounds, low-molecular compounds having an acryloyl group, allyl group or vinyloxy group and a substituted or monosubstituted aminosulfonyl group or substituted sulfonylimino group are preferable.

(3) The alkali-soluble macromolecular compound having an active imide group is preferably those having an active imide group in its molecule. Examples of the macromolecular compound include macromolecular compounds obtained by homopolymerizing a polymerizable monomer comprising a low-molecular compound having one or more active imide groups and one or more polymerizable unsaturated bonds or copolymerizing this monomer with other polymerizable monomers.

Specifically, as such a compound, N-(p-toluenesulfonyl)methacrylamide and N-(p-toluenesulfonyl)acrylamide, for example, may be suitably employed.

(4) Examples of the alkali-soluble resin having a carboxylic acid group may include polymers containing, as a major structural component, a minimum structural unit derived from a compound having one or more carboxylic acid groups and one or more polymerizable unsaturated groups in a molecule.

(5) Examples of the alkali-soluble resin having a phosphoric acid group may include polymers containing, as a major structural component, a minimum structural unit derived from a compound having one or more phosphoric acid groups and one or more polymerizable unsaturated groups in a molecule.

The alkali-soluble resin used in the upper layer of the invention is preferably a polymer compound obtained by polymerizing two or more of a polymerizable monomer having a phenolic hydroxyl group, a polymerizable monomer having a sulfonamide group and a polymerizable monomer having an active amide group.

There is no particular limitation to the copolymerization ratio of the polymerizable monomers and the combination of the polymerizable monomers. When a polymerizable monomer having a sulfonamide group and/or a polymerizable monomer having an active imide group is copolymerized with a polymerizable monomer having a phenolic hydroxyl group, in particular, the ratio by weight of these components to be compounded is preferably in a range from 50:50 to 5:95 and particularly preferably in a range from 40:60 to 10:90.

It is also preferable that the alkali-soluble resin used in the upper layer of the invention be a polymer compound obtained by copolymerizing another polymerizable monomer in addition to one kind or two or more kinds of polymerizable monomer selected from a polymerizable monomer having a phenolic hydroxyl group, a polymerizable monomer having a sulfonamide group and a polymerizable monomer having an active amide group. The copolymerization ratio used in this case is preferably determined, in terms of achieving superior developing properties, such that the monomer imparting alkali-solubility is contained in an amount of 10 mol % or more, and more preferably 20 mol % or more.

Examples of the other polymerizable monomers that may be used include the following compounds (m1) to (m12), but the invention is not limited thereto.

(m1) Acrylic acid esters and methacrylic acid esters having aliphatic hydroxyl groups such as 2-hydroxyethyl acrylate or 2-hydroxyethyl methacrylate.

(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.

(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate, vinyl chloroacetate, vinyl butylate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10) N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

(m12) Unsaturated carboxylic acid such as acrylic acid, methacrylic acid, maleic anhydride, and itaconic acid.

In the case where the alkali-soluble resin used in the upper layer of the invention is a homopolymer or a copolymer of a polymerizable monomer having a phenolic hydroxyl group, a polymerizable monomer having a sulfonamide group and a polymerizable monomer having an active imide group, it preferably has a weight-average molecular weight of 2,000 or more and a number-average molecular weight of 500 or more. More preferably, it has a weight-average molecular weight of from 5,000 to 300,000, a number-average molecular weight of from 800 to 250,000 and a dispersion degree (weight-average molecular weight/number-average molecular weight) of from 1.1 to 10.

In the case where the alkali-soluble resin used in the upper layer of the invention is a phenol-formaldehyde resin or a cresol-aldehyde resin, it particularly preferably has a weight-average molecular weight of from 500 to 20,000 and a number-average molecular weight of from 200 to 10,000.

The alkali-soluble resin used in the upper layer of the invention is preferably a resin having a phenolic hydroxyl group from the standpoint of being capable of forming strong hydrogen bonding in an unexposed area while readily releasing some of the hydrogen bonds in an exposed area. In particular, a novolak resin is preferred as the resin having a phenolic hydroxyl group.

In the invention, two or more kinds of alkali-soluble resins differing in dissolving rate in an aqueous alkali solution may be used as a mixture, and, in such a case, the mixing ratio thereof may be freely determined. As an alkali-soluble resin that is preferably mixed with the resin having a phenolic hydroxyl group, an acrylic resin is preferable since it has a low compatibility with the resin having a phenolic hydroxyl group, and an acrylic resin having a sulfonamide group is more preferable.

The content of the alkali-soluble resin in the upper layer of the invention is preferably from 50 to 98% by mass, based on the total solid content of the upper layer, from the viewpoint of sensitivity and durability of the recording layer.

[(B) Infrared Absorbing Agent]

It is preferable to add an infrared absorbing agent in at least one of the lower layer and upper layer of the recording layer in the planographic printing plate precursor having a multilayer recording layer according to the invention. As the infrared absorbing agent, the same infrared absorbing agents that are used in the aforementioned monolayer type recording layer may be used.

These infrared absorbing agents may be added in any of the lower layer and the upper layer or may be added in the both. The infrared absorbing agent is preferably added in the upper layer or a place close to the upper layer from the viewpoint of sensitivity. Particularly, in the upper layer, the infrared absorbing agent having dissolution inhibitive ability is added in the same layer as the alkali-soluble resin, which ensures high sensitization and allows the unexposed portion to have anti-alkali solubility and is therefore preferable.

When the infrared absorbing agent is added in the lower layer, on the other hand, higher sensitization can be attained. When the infrared absorbing agent is added to both the upper and lower layers, the infrared absorbing agents added to these layers may be the same or different.

Also, these infrared absorbing agents may be added to the upper and lower layers themselves or may be added in a layer formed separately. In the case of adding these infrared absorbing agents to the separate layer, the separated layer is preferably adjacent to the recording layer.

The amount of the infrared absorbing agent when it is added in the upper layer is preferably 0.01 to 30 mass %, preferably 0.1 to 20 mass % and particularly preferably 0.1 to 10 mass % based on the total solid content of the upper layer from the viewpoint of sensitivity and the durability of the recording layer (film characteristics).

The amount of the infrared absorbing agent when it is added in the lower layer is preferably 0 to 20 mass %, preferably 0 to 10 mass % and particularly preferably 0 to 5 mass % based on the total solid content of the lower layer. When the infrared absorbing agent is added in the lower layer, the solubility of the lower layer is reduced if an infrared absorbing agent having dissolution inhibitive ability is used. The infrared absorbing agent, in turn, produces heat when it is exposed to an infrared laser and it is expected that the solubility of the lower layer is improved. It is therefore necessary to select the types and amounts of compounds in consideration of the balances of these conditions.

In the area ranging from the support to a position close to and 0.2 to 0.3 μm apart from the support, in the lower layer, the heat generated at the time of exposure is diffused to the support and it is therefore difficult to obtain the effect of improving solubility by heat in the area. This reduction in the solubility of the lower layer due to the addition of the infrared absorbing agent causes a decrease in sensitivity. Accordingly, an amount of the infrared absorber added, in which amount the rate of dissolution of the lower layer in a developer (25 to 30° C.) is below 30 nm/sec, is undesirable if the amount falls in the above range.

[(C) Development Inhibitor]

It is preferable to compound a development inhibitor in the upper layer according to the invention with the intention of raising the inhibition (dissolution inhibitive ability) of the upper layer. Particularly, in the case of using an infrared absorbing agent having no dissolution inhibitive ability as the aforementioned infrared absorbing agent, this development inhibitor will be a component essential to retain the alkali resistance of the image portion.

As the development inhibitor to be used in the multilayer type recording layer, the same one as the development inhibitor (C) exemplified as the component of the monolayer type recording layer may be used. For example, a quaternary ammonium salt or polyethylene glycol type compound is preferably used. Also, image colorants which will be explained later include compounds which function as a development inhibitor and are therefore given as preferable examples of the developing inhibitor.

As the quaternary ammonium salt, the same one as the quaternary ammonium salt exemplified as the development inhibitor for the aforementioned monolayer type recording layer may be used.

The amount of the quaternary ammonium salt is preferably 0.1 to 50 mass % and more preferably 1 to 30 mass % based on the total solid content of the upper layer from the viewpoint of development inhibitive effect and the film formation characteristics of the aforementioned alkali-soluble resin.

As the polyethylene glycol compound, the same one as the polyethylene glycol compound exemplified as the development inhibitor for the aforementioned monolayer type recording layer may be used.

The amount of the polyethylene glycol type compound is preferably 0.1 to 50 mass % and more preferably 1 to 30 mass % based on the total solid content of the upper layer from the viewpoint of development inhibitive effect and film formation characteristics.

As to the lactone compound, this compound is effective to obtain the same effect as in the case of the aforementioned monolayer type recording layer. The same compounds as those exemplified in the aforementioned monolayer type recording layer may be used.

The amount of the compound which is represented by the above formula (L-I) or (L-II) and is particularly preferably used among these lactone compounds is preferably 0.1 to 50 mass % and more preferably 1 to 30 mass % based on the total solid content of the upper layer from the viewpoint of the effect of the addition and the effect of image formation characteristics.

Besides the above compounds, it is preferable to combine a material, such as an onium salt, o-quinonediazide compound, aromatic sulfone compound or aromatic sulfonate, which is heat-decomposable and substantially reduces the solubility of the alkali-soluble resin when it is in non-decomposed state from the viewpoint of improving the inhibition of the image portion to a developer.

As the onium salt, the same one as the onium salt exemplified as the development inhibitor for the aforementioned monolayer type recording layer may be used.

As the o-quinonediazides, the same one as the o-quinonediazides exemplified as the development inhibitor for the aforementioned monolayer type recording layer may be used.

The amount of the o-quinonediazide compound is preferably in a range from 1 to 50 mass %, more preferably in a range from 5 to 30 mass % and particularly preferably in a range from 10 to 30 mass % based on the total solid content of the upper layer.

It is also preferable to combine a polymer using, a polymer component, a (meth)acrylate monomer having two or three perfluoroalkyl groups having 3 to 20 carbon atoms in its molecule as described in JP-A No. 2000-187318 for the purpose of strengthening the inhibition and scratch resistance of the surface of the recording layer.

The amount of the polymer to be added is preferably 0.1 to 10 mass % and more preferably 0.5 to 5 mass % based on the total solid content of the upper layer.

[Other Additives]

Upon forming the lower layer and the upper layer of the multilayer-type recording layer, various kinds of additives may further be added, depending on necessity, in addition to the aforementioned essential components, as long as the effect of the invention is not thereby impaired. Examples of the additives are shown below, and these may be added only to the lower layer, only to the upper layer, or to both layers.

<Developing Promoter>

A developing promoter may be added to the upper layer and/or lower layer which are the recording layers in the invention with the intention of improving sensitivity. As such a developing promoter, acid anhydrides, phenols and organic acids which are exemplified as the developing promoter used in the aforementioned monolayer type recording layer may be used.

The ratio of the above acid anhydrides, phenols and organic acids in the total solid content of the lower layer or upper layer is preferably 0.05 to 20 mass %, more preferably 0.1 to 15 mass % and particularly preferably 0.1 to 10 mass %.

<Surfactant>

A surfactant may be added to the upper layer and/or lower layer which are the recording layers in the invention with the intention of bettering coatability and to widen the range of process stability in each developing condition. As such a surfactant, nonionic surfactants or amphoteric surfactants exemplified as the surfactant of the aforementioned monolayer type recording layer may be used.

The ratio of the nonionic surfactant or amphoteric surfactant on the basis of the total solid content in the lower layer or upper layer is preferably 0.01 to 15 mass %, more preferably 0.1 to 5.0 mass % and still more preferably 0.5 to 2.0 mass %.

<Printing Agent/Colorant>

It is possible to add a print-out agent used to obtain a visible image immediately after heating by exposure and to add dyes or pigments as image colorants.

As such a print-out agent or an image colorant, the same print-out agents or image colorants as those exemplified for the aforementioned monolayer type recording layer may be used.

It is preferable to add these dyes in a ratio of 0.01 to 10 mass % and preferably 0.1 to 3 mass % based on the total solid content of the lower or upper layer.

<Plasticizer>

A plasticizer may be added to the upper layer and/or lower layer which are the recording layer in the invention to impart softness to a coating film. As such a plasticizer, the plasticizers as those exemplified for the aforementioned monolayer type recording layer may be used.

These plasticizers may be added in a ratio of 0.5 to 10 mass % and preferably 1.0 to 5 mass % based on the total solid content of the lower or upper layer.

<WAX Agent>

It is possible to add, to the upper layer, a compound which drops the static friction coefficient of the surface of the upper layer according to the invention with the intention of imparting resistance to damages. As such a compound, the same ones as the WAX agents exemplified for the aforementioned monolayer type recording layer may be used. The amount of the wax agent is preferably 0.1 to 10 mass % and more preferably 0.5 to 5 mass %.

(Formation of a Recording Layer)

The recording layer (the lower or upper layer which is a monolayer type recording layer or a multilayer type recording layer) of the planographic printing plate precursor of the invention may be formed generally by dissolving the above components to prepare a recording layer coating solution, which is then applied to a proper support.

Examples of the solvent that may be used herein include ethylene dichloride, cyclohexanone, methyl ethyl ketone, methanol, ethanol, propanol, ethylene glycol monomethyl ether, 1-ethoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone and toluene, but the invention is not limited to these. These solvents may be used independently or in combination of two or more thereof.

In the case of the multilayer-type recording layer, it is desirable, in principle, to form the lower layer and the upper layer separately from each other.

Examples of the method for forming the two layers separately include a method that utilizes a difference in solubility in the solvent between the components contained in the lower layer and the components contained in the upper layer, and a method in which the upper layer is coated and then quickly dried to remove the solvent.

These methods will be described below, but the method for coating the two layers separately is not limited thereto.

In the method utilizing the difference in solubility in solvent between the components contained in the lower layer and the components contained in the upper layer, a solvent system that does not dissolve all the components contained in the lower layer is employed for coating the coating solution for the upper layer. According to this method, the two layers can clearly be formed as separate coated films even when conducting a double-layer coating.

For example, components that are insoluble in a solvent capable of dissolving the alkali-soluble resin component of the upper layer such as methyl ethyl ketone and 1-methoxy-2-propanol solvents, are employed as components of the lower layer, and the lower layer is coated and dried by using a solvent system that dissolves the components of the lower layer. Thereafter, the components of the upper layer containing the alkali-soluble resin as a main component are dissolved, coated and dried by using a solvent that does not dissolve the lower layer, such as methyl ethyl ketone and 1-methoxy-2-propanol, whereby the two layers are separately formed.

Examples of the method of quickly drying the solvent after coating the upper layer include a method of blowing high-pressure air from a slit nozzle disposed substantially perpendicular to the running direction of the web, a method of applying heat energy to the lower surface of the web through a roll (heating roll) to which a heating medium, such as steam, is internally fed, and a method combining these methods.

In order to impart a new function, the lower layer and the upper layer may be partially admixed to such an extent that the effect of the invention remains sufficiently exhibited. The partial admixture can be achieved by controlling the difference in solubility in solvent in the method utilizing the difference in solubility between the layers or controlling the drying rate in the method in which the upper layer is coated and then quickly dried to remove the solvent.

The concentration of the components other than the solvent (total solid content including the additives) in the recording layer coating solution to be coated on the support is preferably from 1 to 50% by mass, respectively.

There are various possible methods for coating the coating composition on the support. Examples thereof include bar coater coating, spin coating, spray coating, curtain coating, dip coating, air knife coating, blade coating and roll coating.

In the case of the multilayer-type recording layer, in order to prevent the lower layer from being damaged upon coating the upper layer, the coating method is preferably a non-contact coating method. Bar coater coating, which is generally used for coating of a solvent-based composition, despite being a contact method. The bar coater coating is desirably effected by forward rotation in order to prevent damage to the lower layer.

The amount of the components of the recording layer to be applied in the monolayer type recording layer is preferably in a range from 0.7 to 4.0 g/m² and more preferably in a range from 0.8 to 3.0 g/m² after dried from the viewpoint of, for example, sensitivity and printing durability.

The amount of the components of the lower layer to be applied in the multilayer type recording layer is preferably in a range from 0.5 to 4.0 g/m² and more preferably in a range from 0.6 to 2.5 g/m² after dried from the viewpoint of, for example, sensitivity and printing durability.

Also, the amount of the components of the upper layer to be applied in the multilayer type recording layer is preferably in a range from 0.05 to 1.0 g/m² and more preferably in a range from 0.08 to 0.7 g/m² after dried from the viewpoint of, for example, sensitivity, developing latitude and scratch resistance.

The total amount of the components of the upper layer and lower layer to be applied is preferably in a range from 0.6 to 4.0 g/m² and more preferably in a range from 0.7 to 2.5 g/m² after dried from the viewpoint of, for example, sensitivity, image reproducibility and printing durability.

[Support]

The support which is used in the planographic printing plate precursors of the invention may be any plate-form product that has necessary strength and endurance and is dimensionally stable. Examples thereof include a paper sheet; a paper sheet on which a plastic (such as polyethylene, polypropylene, or polystyrene) is laminated; a metal plate (such as an aluminum, zinc, or copper plate), a plastic film (such as a cellulose diacetate, cellulose triacetate, cellulose propionate, cellulose lactate, cellulose acetate lactate, cellulose nitrate, polyethylene terephthalate, polyethylene, polystyrene, polypropylene, polycarbonate, or polyvinyl acetal film); and a paper or plastic film on which a metal as described above is laminated or vapor-deposited.

Of these supports, a polyester film or an aluminum plate is preferable in the invention. An aluminum plate is particularly preferable since the plate is good in dimensional stability and relatively inexpensive. Preferable examples of the aluminum plate include a pure aluminum plate, and alloy plates comprising aluminum as the main component and a small amount of different elements. A plastic film on which aluminum is laminated or vapor-deposited may be used. Examples of the different elements contained in the aluminum alloy include silicon, iron, manganese, copper, magnesium, chromium, zinc, bismuth, nickel, and titanium. The content by percentage of the different elements in the alloy is at most 10% by mass.

In the invention, pure aluminum is particularly preferable. However, completely pure aluminum is not easily produced from the viewpoint of metallurgy technology. Thus, aluminum containing a trance amount of the different elements may be used.

As described above, the aluminum plate used in the invention, the composition of which is not specified, may be any aluminum plate that has been known or used hitherto. The thickness of the aluminum plate used in the invention is generally from about 0.1 to 0.6 mm, preferably from 0.15 to 0.4 mm, and more preferably from 0.2 to 0.3 mm.

The aluminum plate may be subjected, depending on necessity, to a surface treatment, such as a surface roughening treatment and an anodic oxidation treatment. The surface treatment will be described below.

Before the surface of the aluminum plate is roughened, the plate is subjected to degreasing treatment with a surfactant, an organic solvent, an aqueous alkaline solution or the like if desired, in order to remove rolling oil on the surface. The roughening treatment of the aluminum plate surface is performed by any one of various methods, for example, by a mechanically surface-roughening method, or a method of dissolving and roughening the surface electrochemically, or a method of dissolving the surface selectively in a chemical manner.

The mechanically surface-roughening method which can be used may be a known method, such as a ball polishing method, a brush polishing method, a blast polishing method or a buff polishing method. The electrochemically surface-roughening method may be a method of performing surface-roughening in a hydrochloric acid or nitric acid electrolyte by use of alternating current or direct current. As disclosed in JP-A No. 54-63902, a combination of the two may be used.

The aluminum plate the surface of which is roughened as described above is subjected to alkali-etching treatment and neutralizing treatment if necessary. Thereafter, the aluminum plate is subjected to anodizing treatment if desired, in order to improve the water holding ability or wear resistance of the surface. The electrolyte used in the anodizing treatment of the aluminum plate is any one selected from various electrolytes which can make a porous oxide film. There is generally used sulfuric acid, phosphoric acid, oxalic acid, chromic acid, or a mixed acid thereof. The concentration of the electrolyte may be appropriately decided dependently on the kind of the electrolyte.

Conditions for the anodizing treatment cannot be specified without reservation since the conditions vary dependently on the used electrolyte. The following conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of the anodic oxide film is less than 1.0 g/m², the printing durability is insufficient or non-image areas of the planographic printing plate are easily injured so that the so-called “injury stains”, resulting from ink adhering to injured portions at the time of printing, are easily generated.

If necessary, the aluminum surface is subjected to treatment for hydrophilicity after the anodizing treatment.

The treatment for hydrophilicity which can be used in the invention may be an alkali metal silicate (for example, aqueous sodium silicate solution) method, as disclosed in U.S. Pat. Nos. 2,714,066, 3,181,461, 3,280,734, and 3,902,734. In this method, the support is subjected to immersing treatment or electrolyzing treatment with aqueous sodium silicate solution. Besides, there may be used a method of treating the support with potassium fluorozirconate disclosed in JP-B No. 36-22063 or with polyvinyl phosphonic acid, as disclosed in U.S. Pat. Nos. 3,276,868, 4,153,461, and 4,689,272.

(Undercoat Layer)

The planographic printing plate precursor may be provided with an undercoat layer between the support and the recording layer according to the need.

As components for the undercoat layer, various organic compounds may be used. Examples thereof include carboxymethylcellulose, dextrin, gum arabic, phosphonic acids having an amino group such as 2-aminoethylphosphonic acid, organic phosphonic acids such as phenylphosphonic acid, naphthylphosphonic acid, alkylphosphonic acid, glycerophosphonic acid, methylenediphosphonic acid and ethylenediphosphonic acid, each of which may have a substituent, organic phosphoric acids such as phenylphosphoric acid, naphthylphosphoric acid, alkylphosphoric acid and glycerophosphoric acid, each of which may have a substituent, organic phosphinic acids such as phenylphosphinic acid, naphthylphosphinic acid, alkylphosphinic acid, and glycerophosphinic acid, each of which may have a substituent, amino acids such as glycine and β-alanine, and hydrochlorides of amines having a hydroxyl group, such as hydrochloride of triethanolamine. These may be used in a mixture form.

Also, the undercoat layer preferably contains a compound having an onium group. The compound having an onium salt is described in detail in each publication of JP-A Nos. 2000-10292 and 2000-108538. Also, besides the above compounds, a compound selected from among macromolecular compounds having a structural unit represented by a poly(p-vinylbenzoic acid) may be used. Specific examples of the compound having an onium group include copolymers of a p-vinylbenzoic acid and a vinylbenzyltriethylammonium salt and copolymers of a p-vinylbenzoic acid and a vinylbenzyltrimethylammonium chloride.

This organic undercoat layer can be formed by the following method: a method of dissolving the above-mentioned organic compound into water, an organic solvent such as methanol, ethanol or methyl ethyl ketone, or a mixed solvent thereof to prepare a solution, applying the solution onto an aluminum plate, and drying the solution to form the undercoat layer; or a method of dissolving the above-mentioned organic compound into water, an organic solvent such as methanol, ethanol or methyl ethyl ketone, or a mixed solvent thereof to prepare a solution, dipping an aluminum plate into the solution to cause the plate to adsorb the organic compound, washing the plate with water or the like, and then drying the plate to form the undercoat layer.

In the former method, the solution of the organic compound having a concentration of 0.005 to 10% by mass can be applied by various methods. In the latter method, the concentration of the organic compound in the solution is from 0.01 to 20% by mass, preferably from 0.05 to 5% by mass, the dipping temperature is from 20 to 90° C., preferably from 25 to 50° C., and the dipping time is from 0.1 second to 20 minutes, preferably from 2 seconds to 1 minute.

The pH of the solution used in this method can be adjusted into the range of 1 to 12 with a basic material such as ammonia, triethylamine or potassium hydroxide, or an acidic material such as hydrochloric acid or phosphoric acid. A yellow dye can be added to the solution in order to improve the reproducibility of the tone of the image recording material.

The coated amount of the organic undercoat layer is appropriately from 2 to 200 mg/m², and preferably from 5 to 100 mg/m², in terms of obtaining sufficient printing durability.

The planographic printing plate precursor thus produced is exposed imagewise and then subjected to a developing treatment.

(Backcoat Layer)

A backcoat layer is formed on the backside of the support of the planographic printing plate precursor of the invention according to the need. As the backcoat layer, coating layers comprising an organic macromolecular compound as described in the publication of JP-A No. 5-45885 or a metal oxide obtained by hydrolysis and polymerization condensation of an organic or inorganic metal compound as described in the publication of JP-A No. 6-35174 are preferably used. Among these coating layers, those comprising a metal oxide obtained from an alkoxy compound of silicon such as Si(OCH₃)₄, Si(OC₂H₅)₄, Si(OC₃H₇)₄ or Si(OC₄H₉)₄ are preferable because these alkoxy compounds are inexpensive and hence, easily available and the coating layer of the metal oxide has an excellent behavior in a developer.

(Exposure)

As a light source of active rays used when the planographic printing plate precursor of the invention is exposed imagewise, a known one may be used without any limitation. The light source is preferably various lasers having a wavelength of about 300 nm to 1200 nm. Among these lasers, solid lasers and semiconductor lasers having an emitting wavelength from 780 nm to 1200 nm in the near-infrared region to the infrared region.

The mechanism of exposure may be any of an internal surface drum system, external surface drum system and flat bed system.

(Developing Treatment)

A developer which may be applied to the developing treatment of the planographic printing plate precursor of the invention has a pH range of, preferably, 12.0 to 13.9, more preferably 12.5 to 13.5 and particularly preferably 12.8 to 13.2 in view of the developing characteristics of the exposed portion. As the developer (hereinafter referred to as a developer including a replenishing solution), conventionally known aqueous alkali solutions may be used. Examples of the developer include inorganic alkali salts such as sodium silicate, potassium silicate, sodium tertiary phosphate, potassium tertiary phosphate, ammonium tertiary phosphate, sodium secondary phosphate, potassium secondary phosphate, ammonium secondary phosphate, sodium carbonate, potassium carbonate, ammonium carbonate, sodium bicarbonate, potassium bicarbonate, ammonium bicarbonate, sodium borate, potassium borate, ammonium borate, sodium hydroxide, ammonium hydroxide, potassium hydroxide and lithium hydroxide. Examples of the developer include organic alkali salts such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine and pyridine. These aqueous alkali solutions may be used either singly or in combinations of two or more.

Of the above-mentioned aqueous alkaline solutions, one preferable developer, which exhibits the effects of the invention effectively, is an aqueous solution having a pH of 12 or more and comprising alkali silicate as a base or alkali silicate obtained by mixing a base with a silicon compound. The aqueous solution is the so-called “silicate developer”. Another preferable developer is the so-called “non-silicate developer”, which does not comprise any alkali silicate but comprises a nonreducing sugar (organic compound having a buffer effect) and a base.

About the former, the developing power of aqueous solution of alkali metal silicate can be adjusted by adjusting the ratio between silicon oxide SiO₂ and alkali metal oxide M₂O, which are components of the silicate, (generally, the mole ratio of [SiO₂]/[M₂O]), and the concentration of the alkali metal silicate. For example, the following is preferably used: an aqueous solution of sodium silicate wherein the mole ratio of SiO₂/Na₂O ([SiO₂[/[Na₂O]] is from 1.0 to 1.5 and the content by percentage of SiO₂ is from 1 to 4% by mass, as disclosed in JP-A No. 54-62004; or an aqueous solution of alkali metal silicate wherein the mole ratio of SiO₂/M is from 0.5 to 0.75 (that is, the mole ratio of SiO₂/M₂O is from 1.0 to 1.5), the content by percentage of SiO₂ is from 1 to 4% by mass, and the content by percentage of potassium in all alkali metals is 20% by gram atom, as disclosed in JP-B No. 57-7427.

The so-called “non-silicate developer”, which does not comprise any alkali silicate but comprises a nonreducing sugar and a base, is also preferable for being used to develop the first and second planographic printing plate precursors of the invention. When this developer is used to develop any one of the planographic printing plate precursors, ink-adsorbing power of the recording layer can be kept better without deteriorating the surface of the recording layer.

This developer contains, as its major components, at least one type of compound selected from non-reducing sugars and at least one type of base and preferably has a pH range from 9.0 to 13.5. Such a non-reducing sugar is a sugar which has neither free aldehyde group nor ketone group and does not exhibit reducibility. These sugars are classified into trehalose type oligosaccharides in which reducing sugars are combined with each other, glycosides in which the reducing groups and non-sugars are combined with each other and sugar alcohols obtained by reducing sugars by hydrogenation and any of these sugars are preferably used.

Examples of the trehalose type oligosaccharide include saccharose and trehalose and examples of the glycoside include an alkyl glycoside, phenol glycoside and mustard oil glycoside. Also, examples of the sugar alcohols include D,L-arabitol, ribitol, xylitol, D,L-sorbitol, D,L-mannitol, D,L-iditol, D,L-talitol, dulcitol and allodulcitol.

Moreover, maltitol obtained by hydrogenating disaccharides and reduced bodies (reduced starch syrup) obtained by hydrogenating oligosaccharides are preferably used. Among these sugars, sugar alcohols and saccharose are particularly preferable non-reducing sugar. Particularly, D-sorbitol, saccharose and reduced starch syrup are preferable because these materials have a buffer action in a moderate pH range and are inexpensive.

These non-reducing sugars may be used either singly or in combinations of two or more. The proportion of the sugars in the developer is preferably 0.1 to 30 mass % and more preferably 1 to 20 mass % from the viewpoint of the effect of buffer action and developing characteristics.

The base combined with the nonreducing sugar(s) may be an alkali agent that has been known so far. Examples thereof include inorganic alkali agents such as sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate and ammonium borate; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

These alkali agents may be used either singly or in combinations of two or more. Among these alkali agents, sodium hydroxide and potassium hydroxide are preferable. This reason is that they enable pH adjustment in a wide pH range by regulating the amount of these agents based on the non-reducing sugar. Also, trisodium phosphate, tripotassium phosphate, sodium carbonate and potassium carbonate are preferable because they themselves have a buffer action.

These alkali agents are added in such an amount as to adjust a developer to a pH of 9.0 to 13.5. Although the amount of the alkali agent to be added is determined corresponding to desired pH and the type and amount of non-reducing sugar, the pH is preferably 10.0 to 13.2.

An alkali buffer solution comprising a weak acid other than sugars and a strong base may be further used together in the developer. As the weak acid used as the buffer solution, those having a dissociation constant (pKa) of 10/0 to 13.2 are preferable.

Such a weak acid is selected from those described in “IONISATION CONSTANTS OF ORGANIC ACIDS INAQUEOUS SOLUTION”, published by Pergamon Press. Examples of the weak acid include alcohols such as 2,2,3,3-tetrafluoropropanol-1 (pKa: 12.74), trifluoroethanol (pKa: 12.37) and trichloroethanol (pKa: 12.24), aldehydes such as pyridine-2-aldehyde (pKa: 12.68) and pyridine-4-aldehyde (pKa: 12.05), compounds having a phenolic hydroxyl group such as salicylic acid (pKa: 13.0), 3-hydroxy-2-naphthoic acid (pKa: 12.84), catechol (pKa: 12.6), gallic acid (pKa: 12.4), sulfosalicylic acid (pKa: 11.7), 3,4-dihydroxysulfonic acid (pKa: 12.2), 3,4-dihydroxybenzoic acid (pKa: 11.94), 1,2,4-trihydroxybenzene (pKa: 11.82), hydroquinone (pKa: 11.56), pyrogallol (pKa: 11.34), o-cresol (pKa: 10.33), resorcinol ((pKa: 11.27), p-cresol (pKa: 10.27) and m-cresol (pKa: 10.09), oximes such as 2-butanonoxime (pKa: 12.45), acetoxime (pKa: 12.42), 1,2-cycloheptanedionedioxime (pKa: 12.3), 2-hydroxybenzaldehydoxime (pKa: 12.10), dimethylglyoxime (pKa: 11.9), ethanediamidodioxime (pKa: 11.37) and acetophenoneoxime (pKa: 11.35), nucleic acid relatives such as adenosine (pKa: 12.56), inosine (pKa: 12.5), guanine (pKa: 12.3), cytosine (pKa: 12.2), hypoxanthine (pKa: 12.1) and xanthine (pKa: 11.9) and other weak acids including diethylaminomethylphosphonic acid (pKa: 12.32), 1-amino-3,3,3-trifluorobenzoic acid (pKa: 12.29), isopropylidenediphosphonic acid (pKa: 12.10), 1,1-ethylidenediphosphonic acid (pKa: 11.5), 1,1-ethylidene 1-hydroxydiphosphate (pKa: 11.52), benzimidazole (pKa: 12.86), thiobenzamide (pKa: 12.8), picolinethioamide (pKa: 12.55) and barbituric acid (pKa: 12.5).

Among these weak acids, sulfosalicylic acid and salicylic acid. As the base used in combination with these weak acids, sodium hydroxide, ammonium hydroxide, potassium hydroxide and lithium hydroxide are preferably used. These alkali agents are used either singly or in combinations of two or more. The aforementioned various alkali agents are adjusted to a desired pH range according to the concentration and combination prior to use.

Various surfactants and organic solvents may be added to the developer according to the need for the purpose of promoting developing characteristics, dispersing developing residues and improving the hydrophilic properties of the image portion of the printing plate. Preferable examples of the surfactant include an anionic type, cationic type, nonionic type and amphoteric type.

Preferable examples of the surfactant include nonionic surfactants such as polyoxyethylene alkyl ethers, polyoxyethylene alkylphenyl ethers, polyoxyethylene polystyrylphenyl ethers, polyoxyethylene polyoxypropylenealkyl ethers, glycerin fatty acid partial esters, sorbitan fatty acid partial esters, pentaerythritol fatty acid partial esters, propylene glycol mono-fatty acid esters, cane sugar fatty acid partial esters, polyoxyethylenesorbitan fatty acid esters, polyoxyethylenesorbitol fatty acid esters, polyethylene glycol fatty acid esters, polyglycerin fatty acid esters, polyoxyethylated castor oils, polyoxyethylene glycerin fatty acid partial esters, fatty acid diethanolamides, N,N-bis-2-hydroxyalkylamines, polyoxyethylenealkylamine, triethanolamine fatty acid ester and trialkylamine oxide, anionic surfactants such as fatty acid salts, abietic acids, hydroxyalkane sulfonates, alkane sulfonates, dialkyl sulfosuccinate, straight-chain alkylbenzene sulfonates, branched alkylbenzene sulfonates, alkylnaphthalene sulfonates, alkylphenoxypolyoxyethylenepropyl sulfonates, polyoxyethylene alkylsulfophenyl ether salts, sodium N-methyl-N-oleyltaurate, disodium N-alkylsulfosuccinic acid monoamide, petroleum oil sulfonates, sulfated beef tallow oil, sulfates of fatty acid alkyl ester, alkyl sulfates, polyoxyethylene alkyl ether sulfates, fatty acid monoglyceride sulfates, polyoxyethylene alkylphenyl ether sulfates, polyoxyethylene styrylphenyl ether sulfates, alkyl phosphates, polyoxyethylene alkyl ether phosphates, polyoxyethylene alkylphenyl ether phosphates, partially saponified styrene/maleic acid anhydride copolymers, partially saponified olefin/maleic acid copolymers and naphthalene sulfonate formalin condensates, cationic surfactants such as alkylamine salts, quaternaly ammonium salts, e.g., tetrabutylammonium bromide, polyoxyethylenealkylamines and polyethylenepolyamine derivatives and amphoteric surfactants such as carboxybetaines, aminocarboxylic acids, sulfobetaines, aminosulfates and imidazolines. The term “polyoxyethylene” in the above compounds may be replaced with polyoxyalkylenes such as “polyoxymethylene”, “polyoxypropylene” or “polyoxybutyrene”. The resulting surfactants are also given as examples of the surfactant used in the invention.

Given as more preferable examples of the surfactant used in the invention are fluorine type surfactants containing a perfluoroalkyl group in a molecule. Specific examples of the fluorine type surfactant include an anionic type such as perfluoroalkyl carboxylates, perfluoroalkyl sulfonates and perfluoroalkyl phosphates, amphoteric type such as perfluoroalkyl betaines, cationic type such as perfluoroalkyltrimethylammonium salts and nonionic type such as perfluoroalkylamine oxides, perfluoroalkylethylene oxide adducts, perfluoroalkyl group- or hydrophilic group-containing oligomers, perfluoroalkyl group-, hydrophilic group- or lipophilic group-containing oligomers and perfluoroalkyl group- or lipophilic group-containing urethanes. The above surfactants may be used either singly or in combinations of two or more. The surfactant is added in a developer in an amount range from 0.001 to 10 mass % and preferably 0.01 to 5 mass %.

Various developing stabilizers may be used in the developer. Preferable examples of the developing stabilizer include polyethylene glycol adducts of sugar alcohols, tetraalkylammonium salts such as tetrabutylammonium hydroxide, phosphonium salts such as tetrbutylphosphonium bromide and iodonium salts such as diphenyliodonium chloride as described in the publication of JP-A No. 6-282079.

Moreover, anionic surfactants or amphoteric surfactants as described in the publication of JP-A No. 50-51324, water-soluble cationic polymers as described in the publication of JP-A No. 55-95946 and water-soluble amphoteric high-molecular electrolytes as described in the publication of JP-A No. 56-142528 may be exemplified.

Examples of the surfactant used in the invention also include organic boron compounds to which an alkylene glycol is added as described in the publication of JP-A No. 59-84241, polyoxyethylene/polyoxypropylene block copolymer type water-soluble surfactants as described in the publication of JP-A No. 60-111246, alkylenediamine compounds in which polyoxyethylene/polyoxypropylene are substituted as described in the publication of JP-A No. 60-129750, polyethylene glycols having a weight average molecular weight of 300 or more as described in the publication of JP-A No. 61-215554, fluorine-containing surfactants having a cationic group as described in JP-A No. 63-175858 and water-soluble ethylene oxide adduct compounds and water-soluble polyalkylene compounds obtained by adding 4 mol or more of ethylene oxide to acids or alcohols as described in the publication of JP-A No. 2-39157.

An organic solvent is added to the developer according to the need. Such an organic solvent is selected from those having a solubility of 10 mass % or less and preferably 5 mass % or less in water. Examples of the organic solvent include 1-phenylethanol, 2-phenylethanol, 3-phenyl-1-propanol, 4-phenyl-1butanol, 4-phenyl-2butanol, 2-phenyl-1-butanol, 2-phenoxyethanol, 2benzyloxyethanol, o-methoxybenzyl alcohol, m-methoxybenzylalcohol, p-methoxybenzyl alcohol, benzyl alcohol, cyclohexanol, 2-methylcyclohexanol, 3-methylcyclohexanol, 4-methylcyclohexanol, N-phenylethanolamine and N-phenyldiethanolamine.

The content of the organic solvent is 0.1 to 5 mass % based on the total amount of the solution to be used. The amount of the organic solvent relates closely to the amount of the surfactant to be used. It is preferable to increase the amount of the surfactant along with an increase in the amount of the organic solvent. This reason is that if the amount of the surfactant is small and the organic solvent is used in a large amount, the organic solvent is dissolved incompletely and it is therefore not expected to secure good developing characteristics.

A reducing agent may be further added to the developer. This developer serves to prevent the printing plate from being contaminated. Preferable examples of the organic reducing agent include phenol compounds such as thiosalicylic acid, hydroquinone, menthol, methoxyquinone, resorcin and 2-methylresorcin and amine compounds such as phenylenediamine and phenylhydrazine. More preferable examples of an inorganic reducing agent include sodium salts, potassium salts and ammonium salts of inorganic acids such as sulfurous acid, sulfurous acid hydroacid, phosphorous acid, phosphorous acid hydroacid, phosphorous acid dihydroacid, thiosulfuric acid and dithionic acid.

Among these reducing agents, sulfites have a particularly high contamination preventive effect. These reducing agents are contained in an amount of, preferably, 0.05 to 5 mass % based on the developer in the operation.

An organic carboxylic acid may be further added to the developer. Preferable organic carboxylic acid is aliphatic carboxylic acids and aromatic carboxylic acids having 6 to 20 carbon atoms. Specific examples of the aliphatic carboxylic acid include caproic acid, enanthylic acid, caprylic acid, lauric acid, myristic acid, palmitic acid and stearic acid. Alkanic acids having 8 to 12 carbon atoms are particularly preferable. Also, the organic carboxylic acid may be an unsaturated fatty acid or a branched carbon chain compound. Examples of the aromatic carboxylic acid include compounds provided with a benzene ring, naphthalene ring or anthracene ring which is substituted with a carboxylic acid. Specific examples of aromatic carboxylic acid include o-chlorobenzoic acid, p-chlorobenzoic acid, o-hydroxybenzoic acid, p-hydroxybenzoic acid, o-aminobenzoic acid, p-aminobenzoic acid, 2,4-dihydroxybenzoic acid, 2,5-dihydroxybenzoic acid, 2,6-dihydroxybenzoic acid, 2,3-dihydroxybenzoic acid, 3,5-dihydroxybenzoic acid, gallic acid, 1-hydroxy-2-naphthoic acid, 3-hydroxy-2-naphthoic acid, 2-hydroxy-1-naphthoic acid, -naphthoic acid and 2-naphthoic acid, hydroxynaphthoic acid being particularly effective.

The aforementioned aliphatic or aromatic carboxylic acid is preferably used in the form of a sodium salt, potassium salt or ammonium salt to raise water-solubility. There is no particular limitation to the content of the organic carboxylic acid in the developer used in the invention. However, if the content is less than 0.1 mass %, only insufficient effect is obtained. On the other hand, if the content exceeds 10 mass %, not only an effect corresponding to the content is not obtained but also the dissolution of other additives is inhibited when these additives are used together. Therefore, the amount of the organic carboxylic acid is preferably 0.1 to 10 mass % and more preferably 0.5 to 4 mass % based on the developer when the developer is used in the operation.

The developer may be compounded of an antiseptic, colorants, thickener, antifoaming agent and water softener. Examples of the water softener include polyphosphoric acid and its sodium salts, potassium salts or ammonium salts, aminopolycarboxylic acids such as ethylenediaminetetraacetic acid, diethylenetriaminepentaacetic acid, triethylenetetraminehexaacetic acid, hydroxyethylethylenediaminetriacetic acid, nitrilotriacetic acid, 1,2-diaminocyclohexanetetraacetic acid and 1,3-diamino-2-propanoltetraacetic acid and their sodium salts, potassium salts and ammonium salts, aminotri(methylenephosphonic acid), ethylenediaminetetra(methylenephosphonic acid), diethylenetriaminepenta(methylenephosphonic acid), triethylenetetraminehexa(methylenephosphonic acid), hydroxyethylethylenediaminetri(methylenephosphonic acid) and 1-hydroxyethane-1,1-diphosphonic acid and their sodium salts, potassium salts or ammonium salts.

Generally, the amount of the water softener to be used is in a range from 0.01 to 5 mass % and preferably 0.01 to 0.5 mass % based on the developer when the developer is used, although its optimum value differs depending on a chelating process, the hardness of hard water to be used and the amount of the hard water. When the amount is less than this range, the purpose intended is attained incompletely whereas when the amount exceeds this range, this has an adverse influence on the image portion, for example, color voids. The residual component of the developer is water. It is advantageous in conveyance that the developer is stored in the state of a concentrated solution more reduced in the amount of water than a solution actually used and the concentrated solution is diluted with water in actual use. The concentration in this case is properly increased to the extent that the separation and precipitation of each component are not caused.

As the developer used in invention, a developer as described in the publication of JP-A No. 6-282079 may also be used. This developer is a developer containing an alkali metal silicate having a SiO₂/M₂O (M represents an alkali metal) ratio of 0.5 to 2.0 and a water-soluble ethylene oxide addition compound obtained by adding 5 mol or of ethylene oxide to a sugar alcohol having 4 or more hydroxyl groups. The sugar alcohol is a polyhydric alcohol corresponding to one obtained by reducing an aldehyde group and ketone group of the sugar into a primary alcohol and a secondary alcohol respectively.

Specific examples of the sugar alcohol include D,L-threitol, erythritol, D,L-arabitol, ribitol, xylitol, D,L-sorbitol, D,L-mannitol, D,L-iditol, D,L-talitol, dulcitol and allodulcitol, and also include di-, tri-, tetra-, penta- or hexa-glycerin obtained by condensing sugar alcohols.

The aforementioned water-soluble ethylene oxide addition compound is obtained by adding 5 mol or more of ethylene oxide to 1 mol of the above sugar alcohol. Moreover, propylene oxide may be block-copolymerized with the ethylene oxide addition compound to the extent that the dissolution of the compound is within an allowable level. These ethylene oxide addition compound may be used either singly or in combinations of two or more.

The amount of these water-soluble ethylene oxide addition compounds to be added is properly 0.001 to 5 mass % and preferably 0.001 to 2 mass % based on the developer (working solution).

The aforementioned various surfactants and organic solvents may be further added to the developer according to the need for the purpose of promoting developing characteristics, dispersing developing residues and improving the hydrophilic properties of the image portion of the printing plate.

The planographic printing plate precursor developed using the developer having such a composition is subjected after-treatment performed using rinsing water, a rinsing solution containing surfactants and the like and a finisher or a protective gum solution containing gum arabic and a starch derivative as major components. For the after-treatment of the planographic printing plate precursor of the invention, these treatments are used in various combinations.

In plate making and printing fields in recent years, an automatic developing machine for PS plates has been widely used for rationalization and standardization of plate making works. This automatic developing machine is usually provided with a developing section and an aftertreating section, comprising a unit for carrying a PS plate, vessels for each processing solution and a spraying unit, wherein each processing solution which is pumped up is sprayed from a spray nozzle while carrying the exposed PS plate horizontally to carry out developing treatment. Also, a method has been known recently in which a PS plate is carried by an in-liquid guide roll with dipping it in a processing solution vessel filled with a processing solution. Also, a method has been known in which a fixed and small amount of rinsing water is supplied to the surface of a plate to rinse after the plate is developed and the waste water is reused as water for diluting an undiluted solution of a developer.

In such an automatic treatment, the treatment may be carried out with supplying a replenishing solution to each processing solution corresponding to throughput and operation time. Also, a so-called nonreturnable treating system may be applied in which a substantially unused process solution is used to carry out treatment.

In the planographic printing plate precursor of the invention, when unnecessary image portions (e.g., traces of film edges of the original image film) are found in the resulting planographic printing plate obtained by imagewise exposure, development, washing and/or rinsing with water and/or gumming, the unnecessary image portions are preferably erased. The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

The planographic printing plate obtained as described above is, if desired, coated with a desensitizing gum, and subsequently the plate can be made available for a printing step. When it is desired to make a planographic printing plate have a higher degree of printing resistance, baking treatment is applied to the planographic printing plate.

In a case where the planographic printing plate is subjected to the baking treatment, it is preferable that before the baking treatment takes place the plate is treated with a surface-adjusting solution as described in JP-B No. 61-2518, or JP-A Nos. 55-28062, 62-31859 or 61-159655.

This method of treatment is, for example, a method of applying the surface-adjusting solution onto the planographic printing plate with a sponge or absorbent cotton infiltrated with the solution, a method of immersing the planographic printing plate in a vat filled with the surface-adjusting solution, or a method of applying the surface-adjusting solution to the planographic printing plate with an automatic coater. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a baking processor (for example, a baking processor (BP-1300) sold by Fuji Photo Film Co., Ltd.) or the like. In this case the heating temperature and the heating time, which depend on the kind of components forming the image, are preferably from 180 to 300° C. and from 1 to 20 minutes, respectively.

If necessary, a planographic printing plate subjected to baking treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted. The planographic printing plate obtained as a result of such treatments is applied to an offset printing machine or to some other printing machine, and is used for printing on a great number of sheets.

### EXAMPLES

The present invention will be explained by way of examples, which, however, are not intended to be limiting of the invention.

### Examples 1 to 3 and Comparative Example 1

(Production of a Support)

(Aluminum Plate)

An aluminum alloy comprising 0.06% by mass of Si, 0.30% by mass of Fe, 0.025% by mass of Cu, 0.001% by mass of Mn, 0.001% by mass of Mg, 0.001% by mass of Zn and 0.03% by mass of Ti, with the balance made of Al and inevitable impurities, was used to prepare a molten metal. The molten metal was filtrated, and then an ingot having a thickness of 500 mm and a width of 1200 mm was produced by DC casting.

Its surface was shaved by a thickness of 10 mm on average with a surface-shaving machine, and then the ingot was kept at 550° C. for about 5 hours. When the temperature thereof lowered to 400° C., a hot rolling machine was used to produce a rolled plate having a thickness of 2.7 mm. Furthermore, a continuous annealing machine was used to thermally treat the plate thermally at 500° C. Thereafter, the plate was finished by cold rolling so as to have a thickness of 0.24 mm. In this way, an aluminum plate in accordance with JIS 1050 was yielded.

The short diameter of the average crystal grain size of the resultant aluminum was 50 μm, and the long diameter thereof was 300 μm. This aluminum plate was made so as to have a width of 1030 mm. Thereafter, the plate was subjected to the following surface treatment.

(Surface Treatment)

As surface treatment, the following treatments (a) to (k) were continuously conducted. After each of the treatments and water washing, liquid on the plate was removed with nip rollers.

(a) Mechanical Surface-Roughening Treatment

While supplying a suspension (specific gravity: 1.12) of an abrasive agent (pumice) in water, as an abrading slurry, onto a surface of the aluminum plate, the surface was subjected to mechanical surface-roughening treatment with rotating roller-form nylon brushes.

The average grain size of the abrasive agent was 30 μm. The maximum grain size was 100 μm. The material of the nylon brushes was 6,10-nylon, the bristle length thereof was 45 mm, and the bristle diameter thereof was 0.3 mm. The nylon brushes were each obtained by making holes in a stainless steel cylinder having a diameter of 300 mm and then planting bristles densely therein. The number of the rotating brushes used was three. The distance between the two supporting rollers (diameter: 200 mm) under each of the brushes was 300 mm.

Each of the brush rollers was pushed against the aluminum plate until the load of a driving motor for rotating the brush became 7 kW larger than the load before the brush roller was pushed against the aluminum plate. The rotating direction of the brush was the same as the moving direction of the aluminum plate. The speed of rotation of the brush was 200 rpm.

(b) Alkali Etching Treatment

A 70° C. aqueous solution having a NaOH (caustic soda) concentration of 2.6% by mass and an aluminum ion concentration of 6.5% by mass was sprayed onto the aluminum plate obtained as described above to etch the aluminum plate, thereby dissolving 10 g/m² of the aluminum plate. Thereafter, the aluminum plate was washed with sprayed water.

(c) Desmut Treatment

The aluminum plate was subjected to desmut treatment with a 30° C. aqueous solution having a nitric acid concentration of 1% by mass (and containing 0.5% by mass of aluminum ions), which was sprayed, and then washed with sprayed water. The aqueous nitric acid solution used in the desmut treatment was waste liquid from a process of conducting electrochemical surface-roughening treatment using alternating current in an aqueous nitric acid solution.

(d) Electrochemical Surface-Roughening Treatment

Alternating voltage having a frequency of 60 Hz was used to conduct electrochemical surface-roughening treatment continuously. The electrolyte used at this time was a 10.5 g/L solution of nitric acid in water (containing 5 g/L of aluminum ions and 0.007% by mass of ammonium ions), and the temperature thereof was 50° C. The waveform of the alternating current from a power source was a trapezoidal waveform shown in FIG. 2. The time TP until the current value was raised from zero to a peak was 0.8 msec, and the duty ratio of the current was 1:1. The trapezoidal wave alternating current was used, and a carbon electrode was set as a counter electrode to conduct the electrochemical surface-roughening treatment. Ferrite was used as an auxiliary anode.

The density of the current was 30 A/dm² when the current was at the peak. The total electricity quantity when the aluminum plate functioned as an anode was 220 C/dm². 5% of the current sent from the power source was caused to flow into the auxiliary anode. Thereafter, the aluminum plate was washed with sprayed water.

(e) Alkali Etching Treatment

An aqueous solution having a caustic soda concentration of 2.6% by mass and an aluminum ion concentration of 6.5% by mass was used for spray to etch the aluminum plate at 32° C. so as to dissolve 0.50 g/m² of the aluminum plate, thereby removing smut components made mainly of aluminum hydroxide and generated when the alternating current was used to conduct the electrochemical surface-roughening treatment in the previous process, and further dissolving edges of formed pits so as to be made smooth. Thereafter, the aluminum plate was washed with sprayed water.

(f) Desmut Treatment

The aluminum plate was subjected to desmut treatment with a 30° C. aqueous solution having a nitric acid concentration of 15% by mass (and containing 4.5% by mass of aluminum ions), which solution was sprayed. The aluminum plate was then washed with sprayed water. The aqueous nitric acid solution used in the desmut treatment was waste liquid from the process of conducting the electrochemical surface-roughening treatment using the alternating current in the aqueous nitric acid solution.

(g) Electrochemical Surface-Roughening Treatment

Alternating voltage having a frequency of 60 Hz was used to conduct electrochemical surface-roughening treatment continuously. The electrolyte used at this time was a 5.0 g/L solution of hydrochloric acid in water (containing 5 g/L of aluminum ions), and the temperature thereof was 35° C.

The waveform of the alternating current from a power source was the trapezoidal waveform shown in FIG. 2. The time TP until the current value was raised from zero to a peak was 0.8 msec, and the duty ratio of the current was 1:1. The trapezoidal wave alternating current was used, and a carbon electrode was set as a counter electrode to conduct the electrochemical surface-roughening treatment. Ferrite was used as an auxiliary anode. The electrolyte bath used was the bath illustrated in FIG. 3.

The density of the current was 25 A/dm² when the current was at the peak. The total electricity quantity when the aluminum plate functioned as an anode was 50 C/dm². Thereafter, the aluminum plate was washed with sprayed water.

(h) Alkali Etching Treatment

An aqueous solution having a caustic soda concentration of 2.6% by mass and an aluminum ion concentration of 6.5% by mass was sprayed onto the aluminum plate to etch the plate at 32° C. so as to dissolve 0.10 g/m² of the plate, thereby removing smut components made mainly of aluminum hydroxide and generated when the alternating current was used to conduct the electrochemical surface-roughening treatment in the previous process, and further dissolving edges of formed pits so as to be made smooth. Thereafter, the aluminum plate was washed with sprayed water.

(i) Desmut Treatment

The aluminum plate was subjected to desmut treatment with a 60° C. aqueous solution having a sulfuric acid concentration of 25% by mass (and containing 0.5% by mass of aluminum ions), which solution was sprayed The aluminum plate was then washed with sprayed water.

(j) Anodizing Treatment

An anodizing machine having a structure illustrated in FIG. 4 (the length of each of first and second electrolyzing sections 63a and 63b being 6 m, the length of each of first and second power feeding sections 62a and 62b being 3 m, and the length of each of first and second power feeding electrodes being 2.4 m) was used to conduct anodizing treatment. Sulfuric acid was used in the electrolytes supplied to the first and second electrolyzing sections. The electrolytes each had a sulfuric acid concentration of 50 g/L (and contained 0.5% by mass of aluminum ions), and the temperature thereof was 20° C. Thereafter, the plate was washed with sprayed water. The density of ultimately formed oxide film was 2.7 g/m².

(k) Treatment with Alkali Metal Silicate

The aluminum support obtained by the anodizing treatment was immersed into a treatment tank containing a 45° C. aqueous solution of #3 sodium silicate (concentration of sodium silicate: 1.5% by mass) for 10 seconds, so as to subject the support to treatment with the alkali metal silicate (silicate treatment). Thereafter, the support was washed with sprayed water. In this way, a support whose surface had been made hydrophilic with silicate was obtained. Onto this aluminum support was applied an undercoat solution having the following composition, and then the resultant was dried at 80° C. for 15 seconds to form a coating. The amount of the dried coating was 7 mg/m².

<Undercoat Solution Composition>

| | |
|---|---|
| Compound shown below | 0.3 g |
| Methanol | 100 g |
| Water | 1 g |

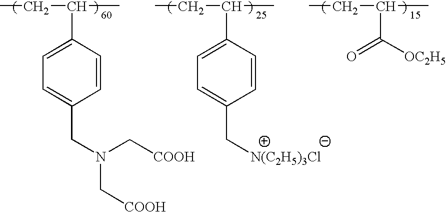

Weight average molecular weight 25,000

(Formation of a Recording Layer (Multilayer))

A lower layer coating solution having the following composition was applied to the obtained support with the undercoat layer such that the dry coating amount was 0.80 g/m² by using a bar coater, then dried at 160° C. for 44 seconds, and then immediately cooled using cool air at 17 to 20° C. until the temperature of the support was 35° C.

Thereafter, an upper layer coating solution having the following composition was applied to the lower layer such that the dry amount was 0.25 g/m² by using a bar coater, then dried at 148° C. for 25 seconds and then cooled gradually using cool air at 20 to 26° C., to obtain a planographic printing plate precursor.

<Lower Layer Coating Solution>

| | |
|---|---|
| Macromolecular compound described | 2.133 g |
| in Table 1 shown below | |
| Cyanine dye A (structure as described below) | 0.134 g |
| 4,4′-bishydroxyphenylsulfone | 0.126 g |
| Tetrahydrophthalic acid anhydride | 0.190 g |
| p-Toluenesulfonic acid | 0.008 g |
| 3-Methoxy-4-diazophenylamine hexafluorophosphate | 0.032 g |
| Dye obtained by changing the counter anion | 0.0781 g |
| of Ethyl Violet to 6-hydroxy-β-naphthalenesulfonic acid | |
| Polymer-1 (structure as described below) | 0.035 g |
| Methyl ethyl ketone | 25.41 g |
| 1-Methoxy-2-propanol | 12.97 g |
| γ-butyrolactone | 13.18 g |

Cyanine Dye A 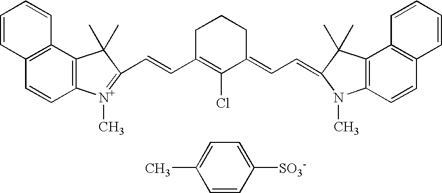
Polymer 1

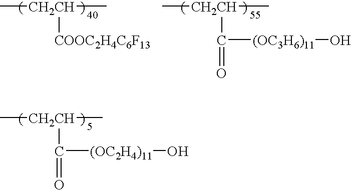

<Upper Layer Coating Solution>

| | | |
|---|---|---|
| m,p-Cresol novolac | 0.348 | g |
| (m/p ratio = 6/4, weight average molecular weight: 4700, | | |
| containing 0.8 mass % unreacted cresol) | | |
| Polymer 3 | 0.1403 | g |
| (structure described below, MEK 30% solution) | | |
| Cyanine dye A (the above structure) | 0.0192 | g |
| Polymer 1 (the above structure) | 0.015 | g |
| Polymer 2 (structure described below) | 0.00328 | g |
| 5-Benzoyl-4-hydroxy-2- | 0.004 | g |
| methoxybenzenesulfonate salt of | | |
| 1-(4-methylbenzyl)-1-phenylpiperidinium | | |
| Surfactant | 0.008 | g |
| (trade name: GO-4, manufactured by | | |
| Nikko Chemicals (K.K.), polyoxyethylenesorbitol fatty | | |
| acid ester, HLB: 8.5) | | |
| Methyl ethyl ketone | 6.79 | g |
| 1-Methoxy-2-propanol | 13.07 | g |

Polymer 2 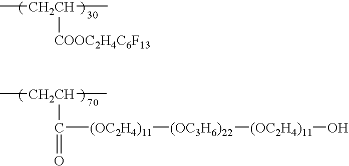
Polymer 3

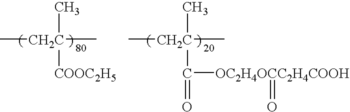

Weight average molecular weight 70,000

(Evaluation of the Planographic Printing Plate Precursor)

(Evaluation of Developing Characteristics and Printing Durability)

Each planographic printing plate precursor obtained in Examples 1 to 3 and Comparative Example 1 was subjected to the following test. A test pattern was written as an image on each planographic printing precursor by using a Trendsetter VFS manufactured by Creo, and the exposure energy was varied. Thereafter, the planographic printing precursor was developed using a PS Processor LP940H, manufactured by Fuji Photo Film Co., Ltd., and charged with a developer diluted such that the conductivity was 43 mS/cm (trade name: DT-2, manufactured by Fuji Photo Film Co., Ltd.). The conditions of developing were temperature of 30° C. and a developing time of 12 seconds. At this time, it was visually confirmed whether any residual film caused by inferior development was present or not in the non-image portions.

This planographic printing plate precursor was set up on a printer Lithrone manufactured by Komori Corporation to carry out continuous printing. Here, the number of copies on which printing was made with sufficient ink density was visually measured to evaluate the printing durability of the planographic printing plate precursor. The larger the number of copies, the higher the printing durability is evaluated to be. The results are shown in Table 1.

(Evaluation of Chemical Resistance)

Each planographic printing plate precursor obtained in Examples 1 to 3 and Comparative Example 1 was evaluated in the following manner. Exposure, developing and printing were carried out in the same manner as in the case of evaluating the above printing durability. However, here a cleaning process of the surface of the plate by using a cleaner (multi-cleaner manufactured by Fuji Photo Film Co., Ltd.) was undertaken every 5000 prints to evaluate the chemical resistance. The larger the number of copies, the higher the chemical resistance is evaluated to be. The results are shown in Table 1.

(Evaluation of Ink Adherence)

As in the above evaluation of chemical resistance, the plate was cleaned when 50,000 copies were printed. Then, the plate was further wiped using water before re-starting printing. The ink adherence was evaluated by the number of copies printed after ink was supplied to the image portions after printing was re-started until a stable printing product was obtained. The results are shown in Table 1 shown below.

TABLE 1

| | | | Printing | Chemical | Copies in |
|---|---|---|---|---|---|
| | | | durability, | resistance, | the ink |
| | | Generation | printed | printed | adherence |
| | Macromolecular | of a residual | copies (×10⁴ | copies (×10⁴ | test (number |
| | compound | film | sheets) | sheets) | of sheets) |
| Example 1 | BP-1 | None | 18.0 | 16.0 | 20 |
| Example 2 | BP-4 | None | 19.0 | 18.0 | 10 |
| Example 3 | BP-5 | None | 19.5 | 19.0 | 10 |
| Comparative | BP-C | None | 17.0 | 11.5 | 25 |
| Example 1 | | | | | |

The structure of the macromolecular compound (BP—C) used in Comparative Example 1 is shown below. The macromolecular compounds used in the examples are specific macromolecular compounds (A), whose structure is described in this specification.

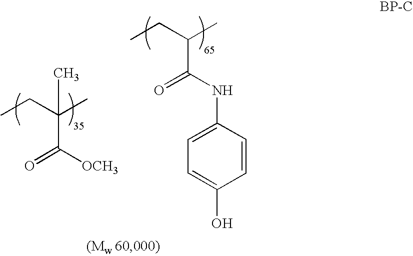

It was found from the results of the above Table 1 that the planographic printing plate precursors of Examples 1 to 3 using specific macromolecular compounds (A), which are the characteristic component of the invention, as a lower layer component gave superior developing characteristics of the non-image portions, printing durability, chemical resistance and ink adherence. On the other hand, it was confirmed that the planographic printing plate precursor of Comparative Example 1, using no specific macromolecular compound (A), was inferior to those of the Examples in printing durability, chemical resistance and ink adherence.

### Examples 4 and 5 and Comparative Example 2

(Production of a Support)

A support for planographic printing plate precursors was produced using the samesubstrate treatment as in Example 1 except that the silicate treatment, after performing the anodic oxidation treatment, was not carried out.

(Formation of a Recording Layer (Monolayer))

A recording layer (monolayer) coating solution having the following composition was applied to the support obtained above and dried such that the dry coating amount was 1.10 g/m² to form a recording layer thereby obtaining a planographic printing plate precursor.

<Recording Layer (Monolayer) Coating Solution>

| | | |
|---|---|---|
| Novolac resin (m/p-cresol ratio = 6/4, | 0.5 | g |
| weight average molecular weight: 7,000 and | | |
| unreacted cresol: 0.5 mass %) | | |
| Macromolecular compound described in Table 2 | 1.0 | g |
| Cyanine dye A (structure as above) | 0.15 | g |
| Phthalic acid anhydride | 0.05 | g |
| p-Toluenesulfonic acid | 0.002 | g |
| Compound obtained by changing the counter anion | 0.02 | g |
| of Ethyl Violet to 6-hydroxy-β-naphthalenesulfonic acid | | |
| Fluorine type Polymer (Megafac F-176 | 0.035 | g |
| (solids: 20%), manufactured by Dainippon Ink | | |
| and Chemicals, Inc. | | |
| Fluorine type Polymer | 0.03 | g |
| (Megafac MCF-312 (solids: 30%), manufactured by | | |
| Dainippon Ink and Chemicals, Incorporated | | |
| Lauryl stearate | 0.03 | g |
| γ-butyrolactone | 8.5 | g |
| 1-Methoxy-2-propanol | 3.5 | g |

(Evaluation of the Planographic Printing Plate Precursor (Printing Durability, Chemical Resistance and Ink Adherence))

Each planographic printing plate precursor obtained in Examples 4 and 5 and Comparative Example 2 was subjected to the same treatments as to exposure, developing and printing. The printing durability, chemical resistance and ink adherence of the printing plate precursor were evaluated in the same manner as in Example 1. The results are shown in table 2.

TABLE 2

| | | | | Copies |
|---|---|---|---|---|
| | | | | in the ink |
| | | Printing | Chemical | adherence |
| | | durability, | resistance, | test |
| | | printed | printed | (number |
| | Macromolecular | copies | copies | of |
| | compound | (×10⁴ sheets) | (×10⁴ sheets) | sheets) |
| Example 4 | BP-2 | 11.5 | 10.0 | 15 |
| Example 5 | BP-8 | 12.5 | 10.5 | 15 |
| Comparative | —* | 8.5 | 4.0 | — |
| Example 2 | | | | |

*Instead of adding the macromolecular compound a total of 1.5 g of Novolak resin was used.

It was found from the results of the above Table 2 that the planographic printing plate precursors of Examples 4 and 5 using specific macromolecular compounds (A), which is the characteristic component of the invention, were superior to the planographic printing plate precursor of Comparative Example 2, using no specific macromolecular compound (A), in printing durability, chemical resistance and ink adherence.

It was also confirmed that, by comparing Examples 1 to 3 with Examples 4 and 5, Examples 1 to 3 in which the recording layer was formed as a multilayer comprising an upper layer and a lower layer and the specific macromolecular compound was added to the lower layer had a particularly significant effect.

What is claimed is:

1. A planographic printing plate precursor comprising:
a support; and
a positive recording layer which is disposed on the support and contains (A) an alkali-soluble high-molecular weight compound having a heterocyclic ring bonded with a mercapto group.

2. The planographic printing plate precursor according to claim 1, wherein the positive recording layer further contains (B) an infrared absorbing agent and is able to form an image by irradiation with infrared rays.

3. The planographic printing plate precursor according to claim 1, wherein the positive recording layer further contains (C), a compound which interacts with the alkali-soluble high-molecular weight compound (A) having a heterocyclic ring bonded with a mercapto group to reduce the solubility thereof in an alkali solution.

4. The planographic printing plate precursor according to claim 3, wherein the positive recording layer further contains (B) an infrared absorbing agent.

5. The planographic printing plate precursor according to claim 3, wherein the compound (C) which reduces the solubility of the high-molecular weight compound (A) in an alkali solution is an infrared absorbing agent.

6. The planographic printing plate precursor according to claim 1, wherein the positive recording layer contains a lower layer comprising the alkali-soluble high-molecular weight compound (A) having a heterocyclic ring bonded with a mercapto group and an upper layer comprising an alkali-soluble resin and a compound which interacts with the alkali-soluble resin to reduce the solubility of the resin in an alkali solution.

7. The planographic printing plate precursor according to claim 6, wherein at least one of the lower layer and upper layer contains the infrared absorbing agent (B).

8. The planographic printing plate precursor according to claim 1, wherein the heterocyclic ring bonded with a mercapto group is an aromatic heterocyclic ring.

9. The planographic printing plate precursor according to claim 8, wherein two or more of the atoms forming the aromatic heterocyclic ring are atoms each independently selected from nitrogen, oxygen or sulfur atoms.

10. The planographic printing plate precursor according to claim 9, wherein three or more of the atoms forming the aromatic heterocyclic ring are atoms each independently selected from nitrogen, oxygen and sulfur atoms.

11. The planographic printing plate precursor according to claim 8, wherein the atomic group forming the aromatic heterocyclic ring contains at least one nitrogen atom.

12. A planographic printing plate precursor comprising:
a support; and
a first recording layer which is disposed on the support and contains (A) an alkali-soluble high-molecular weight compound having a heterocycle bonded with a mercapto group and (C) a compound which interacts with the alkali-soluble high-molecular weight compound having a heterocyclic ring bonded with a mercapto group to reduce the solubility of the high-molecular weight compound in an alkali solution,
wherein there is a release of the interaction between the high-molecular weight compound (A) and the compound (C) caused by irradiation with infrared rays, allowing the mercapto group of the polymer (A) to exhibit solubility in an alkali solution.

13. The planographic printing plate precursor according to claim 12, wherein the first recording layer further contains (B) an infrared absorbing agent.

14. The planographic printing plate precursor according to claim 12, wherein the compound (C) which reduces the solubility of the high-molecular weight compound (A) in an alkali solution is an infrared absorbing agent.

15. The planographic printing plate precursor according to claim 12, the precursor further comprising a second recording layer which is formed on the first recording layer and contains an alkali-soluble resin and a compound which interacts with the alkali-soluble resin to reduce the solubility of the resin in an alkali solution.

16. The planographic printing plate precursor according to claim 15, wherein at least one of the first recording layer or the second recording layer contains an infrared absorbing agent (B).

17. The planographic printing plate precursor according to claim 12, wherein the heterocyclic ring bonded with a mercapto group is an aromatic heterocyclic ring.

18. The planographic printing plate precursor according to claim 17, wherein two or more of the atoms forming the aromatic heterocyclic ring are atoms each independently selected from nitrogen, oxygen or sulfur atoms.

19. The planographic printing plate precursor according to claim 18, wherein three or more of the atoms forming the aromatic heterocyclic ring are atoms each independently selected from nitrogen, oxygen or sulfur atoms.

20. The planographic printing plate precursor according to claim 17, wherein the group of atoms forming the aromatic heterocyclic ring contains at least one nitrogen atom.
